(19) United States
(12) Patent Application Publication
(10) Pub. No.: US 2025/0356314 A1
(43) Pub. Date: Nov. 20, 2025

(54) FLEXIBLE REFERENTIAL DATA STRUCTURES AND METHODS OF USING THE SAME

(71) Applicant: PRISIDIO INC., Naples, FL (US)

(72) Inventors: Glenn SHIMKUS, Naples, FL (US); Paul KOZIARZ, College Grove, TN (US); Josh HEHN, Monticello, IL (US); Sarah MITCHELL, Naples, FL (US); Ram MARAPPAN, Naperville, IL (US); Andrew DEAN, Elmhurst, IL (US)

(21) Appl. No.: 18/871,245

(22) PCT Filed: Jun. 5, 2023
(86) PCT No.: PCT/US2023/024444

§ 371 Date: Dec. 3, 2024

Related U.S. Application Data
(60) Provisional application No. 63/349,450, filed on Jun. 6, 2022.

(51) Int. Cl. G06Q 10/101; G06F 21/62; G06Q 10/10

(52) U.S. Cl. CPC G06Q 10/101; G06F 21/6227; G06Q 10/103

(57) ABSTRACT

Various implementations disclosed herein secure data structures for the uploading, storing, relating, supplementing, and sharing of data and providing notification and action regarding the same. In some examples, data such as or relating to documents, contacts, locations, and tangibles may be uploaded and stored in a secure data structure. The uploaded and stored data may be related, referenced, or otherwise linked to other uploaded stored data (e.g., documents, contacts, locations, and tangibles) in limitless combinations. This referential data may provide express contextual clues regarding the physical locations of important documents and/or the people related to such documents, which may be beneficial in situations where such documents need to be found by third parties.

This patent claims the benefit of U.S. Provisional Application Ser. No. 63/349,450, filed Jun. 6, 2022, and entitled “Flexible Referential Data Structures and Method of using the Same.” U.S. Provisional Application Ser. No. 63/349,450 is hereby incorporated by reference herein in its entirety.

### TECHNICAL FIELD

The present disclosure generally relates to flexible referential data structures and methods of using the same.

### BACKGROUND

Various techniques are used to provide storage in data structures and to provide access thereto. But some data structures lack organization and/or permit access to such data structures in a liberal manner. Other data structures have rigid organizations and/or permit access to such data structures in a conservative manner.

### SUMMARY

Various implementations disclosed herein include secure data structures for the uploading, storing, relating, supplementing, and sharing of data and providing notification and action regarding the same. In some examples, data such as or relating to documents, contacts, locations, and tangibles may be uploaded and stored in a secure data structure (e.g., some or all data elements may be encrypted with its own unique encryption key). The uploaded and stored data may be supplemented with notation data via textual, audio, or visual capture techniques. The uploaded and stored data may be related, referenced, or otherwise linked to other uploaded stored data (e.g., documents, contacts, locations, and tangibles) in limitless combinations. This referential data may provide express contextual clues regarding the physical locations of important documents and/or the people related to such documents, which may be beneficial in situations where such documents need to be found by third parties. Such data structures may be shared in their entirety or in ad-hoc fashion. Users may switch between data structures to which they have access in a quick and efficient manner.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1B illustrate exemplary interfaces for displaying various features of example flexible referential data structures as described herein.

FIGS. 2A-2B illustrate exemplary interfaces for displaying various document related features of example flexible referential data structures as described herein.

FIGS. 3A-3C illustrate exemplary interfaces for displaying various features of example flexible referential data structures as described herein.

FIGS. 4A-4B illustrate exemplary windows for displaying various features of example flexible referential data structures as described herein.

FIGS. 5A-5C illustrate exemplary interfaces for displaying various features of example flexible referential data structures as described herein.

FIGS. 6A-6B illustrate exemplary interfaces for displaying various features of example flexible referential data structures as described herein.

FIGS. 7A-7B illustrate exemplary windows and interfaces for displaying various features of example flexible referential data structures as described herein.

FIG. 8 illustrates exemplary interactive components for relating various features of example flexible referential data structures as described herein.

FIG. 9 illustrates exemplary windows and interactive components for relating various features of example flexible referential data structures as described herein.

FIG. 10 illustrates exemplary windows and interactive components for relating various features of example flexible referential data structures as described herein.

FIG. 11 illustrates exemplary windows and interactive components for relating various features of example flexible referential data structures as described herein.

FIG. 12 illustrates exemplary windows and interactive components for relating various features of example flexible referential data structures as described herein.

FIG. 13 illustrates exemplary windows and interactive components for relating various features of example flexible referential data structures as described herein.

FIG. 14 illustrates exemplary interfaces for relating various features of example flexible referential data structures as described herein.

FIGS. 15A-15B illustrate exemplary interfaces for sharing various features of example flexible referential data structures as described herein.

FIGS. 16A-16B illustrate exemplary interfaces for sharing various features of example flexible referential data structures as described herein.

FIG. 17 illustrates exemplary interfaces for enabling permissions for example flexible referential data structures as described herein.

FIG. 18 illustrates exemplary interfaces for tracking and displaying activity associated with example flexible referential data structures as described herein.

FIGS. 19A-19B illustrate exemplary interfaces for displaying various people related features of example flexible referential data structures as described herein.

FIGS. 20A-20B illustrate exemplary interfaces for displaying various people related features of example flexible referential data structures as described herein.

FIGS. 21A-21B illustrate exemplary interfaces for displaying various places related features of example flexible referential data structures as described herein.

FIGS. 22-23 illustrate exemplary interfaces for displaying various places related features of example flexible referential data structures as described herein.

FIGS. 24A-24B illustrate exemplary interfaces for displaying various things related features of example flexible referential data structures as described herein.

FIG. 25 illustrates exemplary interfaces for inputting various thing related features of example flexible referential data structures as described herein.

FIGS. 26-27 illustrate exemplary interfaces for relating thing related features with document related features and place related features of example flexible referential data structures as described herein.

FIG. 28 illustrates exemplary interfaces for enabling co-ownership of example flexible referential data structures as described herein.

FIG. 29 illustrates exemplary interfaces for displaying invitations and notifications associated with example flexible referential data structures as described herein.

FIGS. 30A-30B illustrate exemplary interfaces for displaying notifications associated with example flexible referential data structures as described herein.

FIGS. 31-34 illustrate exemplary interfaces for displaying notifications associated with example flexible referential data structures as described herein.

FIGS. 35-37 illustrate exemplary interfaces associated with blocking users attempting to access example flexible referential data structures as described herein.

FIGS. 38A-38B illustrate exemplary interfaces for switching between accessible example flexible referential data structures as described herein.

FIG. 39 is a flowchart associated with managing release or transfer of example flexible referential data structures as described herein.

FIG. 40 is a flowchart associated with managing release of example flexible referential data structures as described herein.

FIG. 41 is a flowchart associated with managing transfer of example flexible referential data structures as described herein.

FIG. 42 is a block diagram of example structural components associated with the methods and example flexible referential data structures described herein.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

The flexible referential data structures disclosed herein may be represented as a secure online vault for users who create accounts to upload and store securely important documents and data. Such data structures may be generated based on data elements that are added by a user with an account. In some examples, these data structures may flexibly grow based on a number of data elements that are added by and/or shared with a user. In some examples, the data elements may be associated, be related, or otherwise be made to contain references to each other. In some examples, users may activate an online vault account and utilize various algorithms to encrypt, store, share, and provide access to information in the online vault. In some examples, users that create or otherwise activate a flexible referential data structure may be considered owners. In some examples, owners may designate other users (whom may have their own flexible referential data structure) as co-owners or key holders to the owner's flexible referential data structure. In some examples, co-owners may have the same access and permissions as owners. In some examples, key holders may have limited access. In some examples, any limitations on access may be established by an owner and/or a co-owner.

The flexible referential data structures (e.g., online vault) may be accessed via the web, mobile device applications, computer applications, or the like. In some examples, a user of the flexible referential data structures disclosed herein may be able to upload information that may need to remain locked away or otherwise securely stored until a particular triggering event (e.g., death, disability, incapacity, missing, etc.) occurs. For example, a user may upload information relating to and/or a digital copy of his or her last will and testament. In some such examples, the user can select various people (e.g., one or more other users) for sharing some or all the relevant details about his or her last will and testament. In some examples, the user may share the actual location of the physical copy of the last will and testament for such various people to recover upon the user's death. In some examples, the user may share the combination to the safe in which the physical copy of the last will and testament is located. In some examples, the user may share the location in which the combination (to the safe in which the physical copy of the last will and testament is located) is written down or digitally stored. Based on the various levels of sharing the user determines, one or more people may be provided some or all the information needed to identify the existence of the last will and testament, the digital content of the last will and testament, the storage location of the last will and testament, and/or any other necessary information needed to locate and/or obtain the physical copy of the last will and testament in the event of the user's death. As will be described further herein, the relating and/or otherwise linking of various data elements to share with other users provides improved mechanisms for both the flexible referential data structures and users of the flexible referential data structures to identify, track, and locate stored information.

In some examples, the flexible referential data structures may include routines for reminding users when items are shared with other users for transparency as to what is shared and with whom an item is shared. In some examples, the reminders may be periodic according to a determined frequency (e.g., 6 months). In some examples, the reminder frequency may be set, adjusted, and/or removed by the user. Based on such reminders, a user may edit, un-share, or further share an item. In some examples, the flexible referential data structures may provide user recommendations regarding items (e.g., contacts, documents, places, things, etc.) that should be included within the flexible referential data structures and/or shared with others.

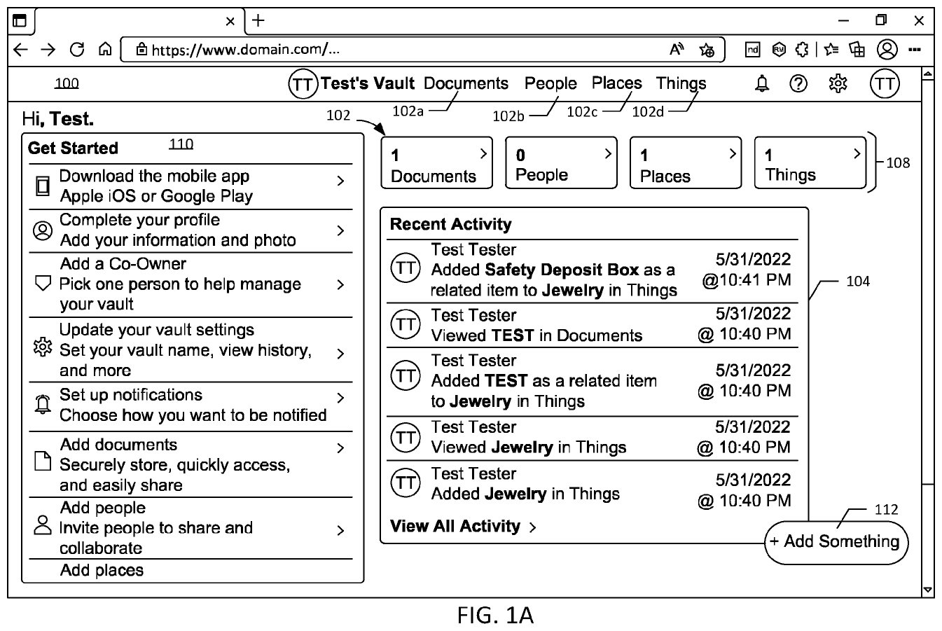

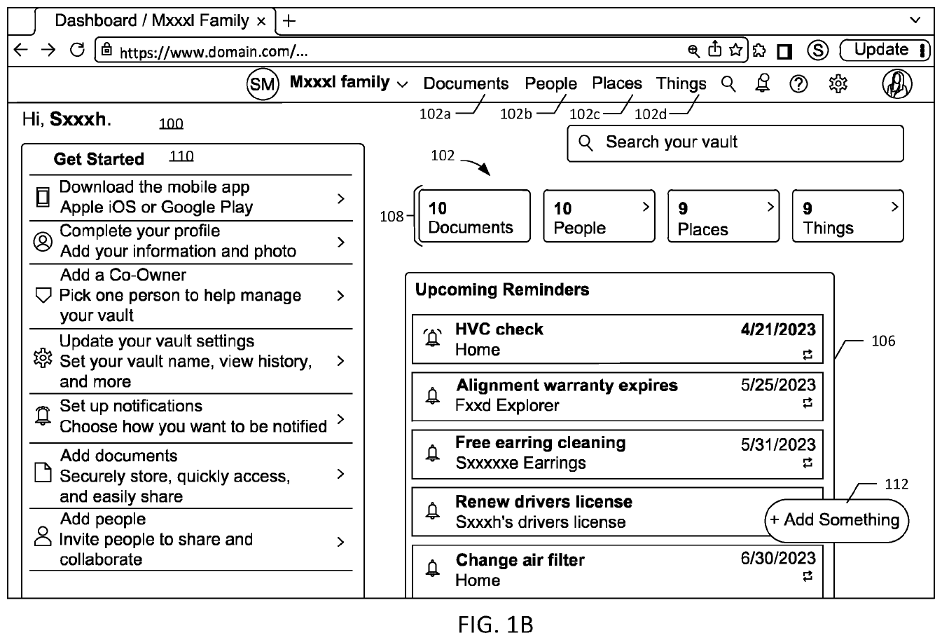

As described herein, various software interfaces illustrate the various attributes, functions, and benefits provided by the flexible referential data structures and methods of using the same disclosed herein. For example, FIG. 1A illustrates an exemplary interface 100 displaying various features of a flexible referential data structure portrayed as an online vault. While the interface 100 is illustrated as a webpage in FIG. 1, the interface 100 may be an interface in a local or mobile application. A user may have an account that identifies (and gives that user access to) data elements 102 that are associated with that user's online vault and/or data elements associated with other user's online vaults (to which that the user has been granted access). The various data elements 102 may be viewed or added from the interface 100 of FIG. 1 to either generate or update the flexible referential data structure. As illustrated, the data elements 102 may include or represent, among other things, documents 102a, people 102b, places 102c, and things 102d. Interface 100 may further include a first region 104 to display recent activity related to the viewing or adding of the various data elements 102. In some examples, as illustrated in FIG. 1B, interface 100 may include a second region 106 to display upcoming reminders. For example, a reminder may be displayed to indicate that the user should check and confirm that the last will and testament of the user is shared with the correct people.

The interface 100 may be a home or starting interface that may enable a user to have a summary of his or her flexible referential data structure. In some examples, interface 100 may further include a summary 108 identifying numbers of each type of data element 102 with the user's flexible referential data structure. In some examples, interface 100 may further include a third region 110 identifying action items for a user to perform to “Get Started.” For example, interface 100 may enable a user to download a different version of the flexible referential data structure (e.g., a mobile application), edit a user profile (e.g., adding user specific information and/or images), add co-owner(s), configure user settings, create and edit notification settings, and/or add instances of data elements 102. The interface 100 may further include a button 112, which may be a shortcut to adding instances of data elements 102 to the flexible referential data structure.

In some examples, upon user selection of the button 112, the flexible referential data structure may provide recommendations of data elements to be uploaded. In some examples, such recommendations may be based on answers to questionnaires provided to a user (e.g., when a user registers for an account). In some examples, such recommendations may be based on user profile information inputted by a user during and/or after account registration. For example, if a user answers a question or updates his or her profile to indicate the user is married, the flexible referential data structure may recommend the addition of a people data element 102b (e.g., add a spouse). In some examples, recommendations may be based on previously added data elements 102. For example, if a user adds a people data element 102b (e.g., a spouse), the flexible referential data structure may recommend data elements 102 associated with a person (e.g., add birth certificate, add a social security card, add a marriage license, etc.). In some examples, machine learning algorithms may build recommendation models based on historical data relating to one or more data elements previously added by one or more other users. In some examples, the machine learning algorithms may further refine, based on user profile data, the recommendation models to make demographic based recommendations.

Document data elements 102a may include, but are not limited to including, electronic documents, images or other representations of paper documents, data about document creation or storage locations, and/or other information about the documents associated with how to find, authenticate, understand, interpret, or otherwise use the documents. People data elements 102b may identify, but are not limited to identifying, people by name or other identifier (e.g., SSN, driver's license number, online vault account ID, etc.) and/or references to online vault accounts, contact information (e.g., e-mail addresses, telephone numbers, etc.), images of, videos of, and/or other information about those other people associated with finding, contacting, communicating with, uniquely identifying, and/or otherwise sharing online vault data elements with them. In some examples, people data elements 102b may be added manually or imported from a contact list (e.g., from an email account, a mobile device, etc.). In some examples, if another user already has an online vault account, their information may be automatically retrieved from that other user's account. Place data elements 102c may identify, but are not limited to identifying, specific places (e.g., addresses, building names, residential unit identifiers, room identifiers, closet identifiers, furniture identifiers, safe identifiers, container identifiers, digital storage locations, digital accounts, etc.), images of, videos of, and/or other information useful in finding, accessing, unlocking, opening, obtaining permission to access, retrieving objects from those locations, and/or otherwise using those locations. Thing data elements 102d may identify, but are not limited to identifying, specific tangible items (e.g., vehicles, personal property, heirlooms, etc.), images of, videos of, and/or other information useful in finding, obtaining, transferring ownership, and/or otherwise using those items.

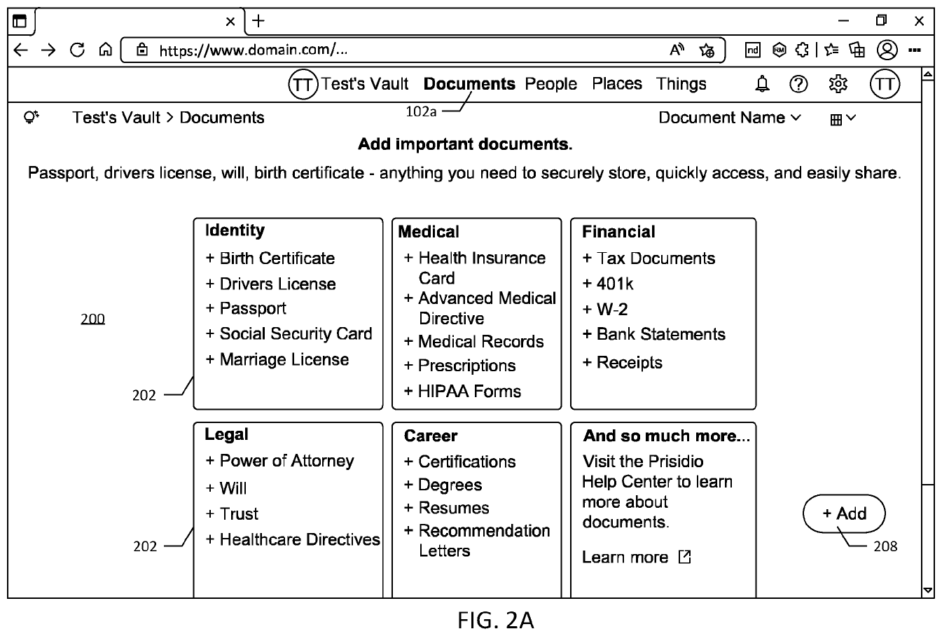

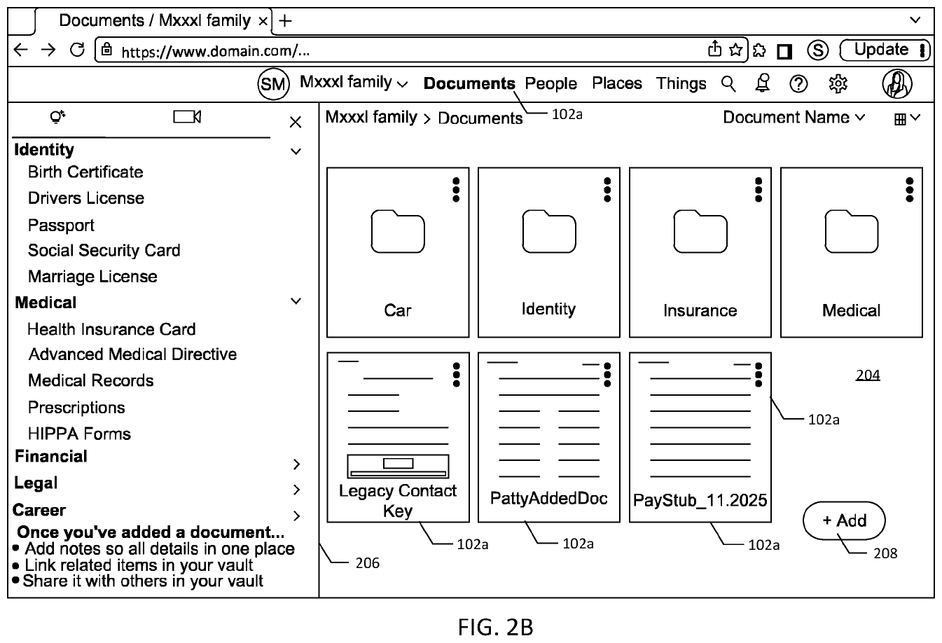

As shown in FIG. 2A, the document data elements 102a may be manipulated in an interface 200. For example, interface 200 may display and/or identify the various document data elements 102a already associated with the flexible referential data structure. The interface 200 may enable a user to edit, share, or delete such existing document data elements 102a. The interface 200 may also enable additional document data elements 102a to be added to the flexible referential data structure. The interface 200 may comprise an interactive list of various types of documents that may be uploaded, stored, encrypted, shared, or otherwise provided access to. For example, birth certificates, drivers licenses, passports, social security cards, marriage licenses, powers of attorney, wills, trusts, healthcare directives, health insurance cards, advanced medical directives, medical records, prescriptions, health insurance portability and accountability act (“HIPAA”) forms, certifications, degrees, resumes, recommendation letters, tax documents, 401k information, W-2s, bank statements, receipts, and the like may be example documents to be utilized in the flexible referential data structures disclosed herein. In some examples, the interface 200 may include separate categories 202 of various types of documents that may be included in the flexible referential data structures disclosed herein. In some examples, the categories 202 may be displayed as boxes within the interface 200, as shown in FIG. 2A.

As shown in FIG. 2B, an alternate interface 204 may display categories 206 in a textual hierarchy. Like the interface 100 in FIG. 1, the interface 200 and the alternate interface 204 may include a button 208, which may be a shortcut to adding instances of document data elements 102a to the flexible referential data structure via either the interface 200 and the alternate interface 204.

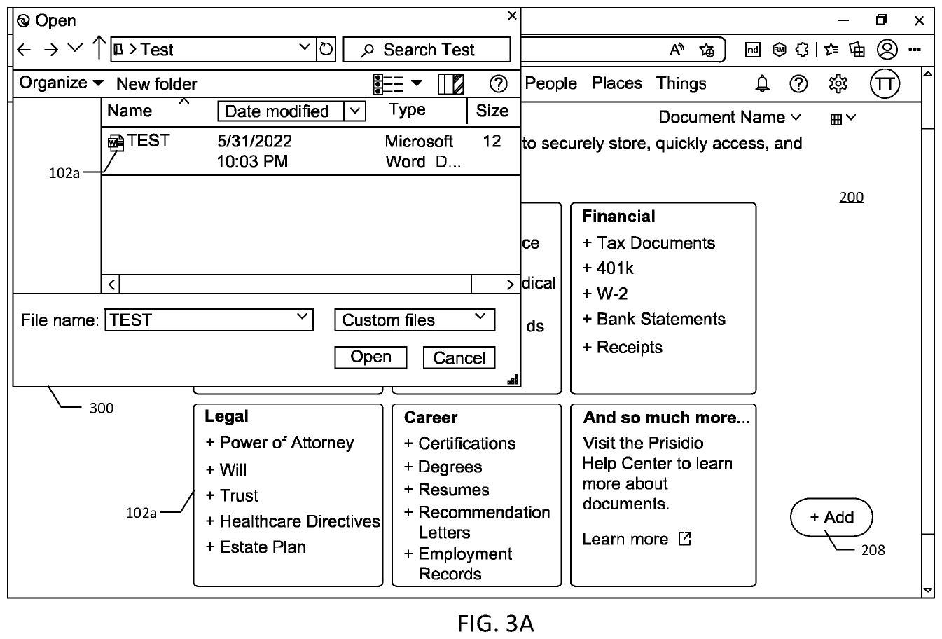

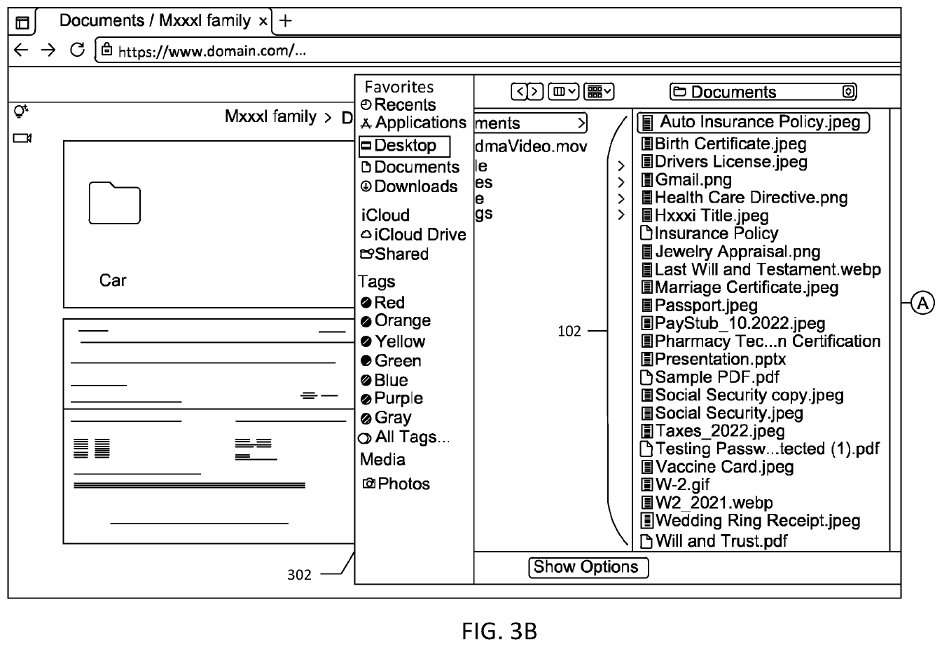

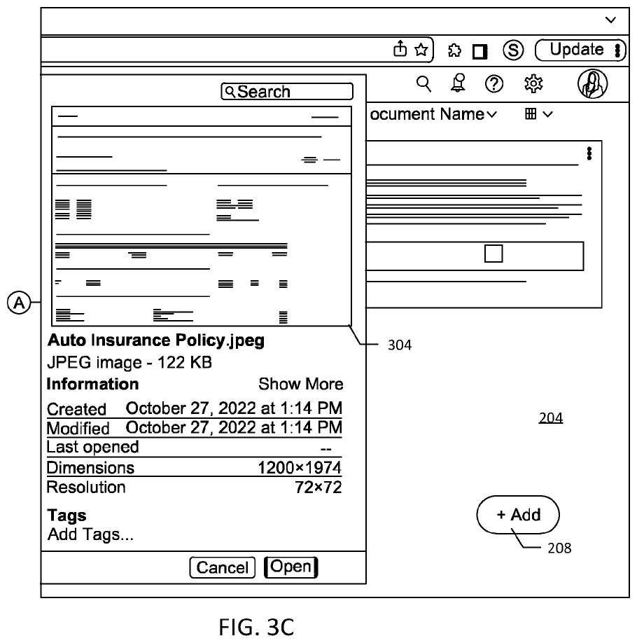

FIG. 3A illustrates an example interface 300 for uploading a document data element 102a. In some examples, interface 300 enables uploading a document data element 102a (or any other data element 102) from a folder stored on a local computer. Other locations may be used such as online or mobile device storage locations. FIG. 3B illustrates an alternative interface 302 that enables uploading a data element 102. As an example, an auto insurance policy 304 may be uploaded. Various data elements 102 that may be uploaded or otherwise added to the flexible referential data structure. Other processes for uploading a data element 102 may include scanning a data element 102, sharing a data element 102 from another application, requesting a data element 102 from another user, taking a photo, adding a data element 102 from a library or cloud storage, dragging and dropping a data element 102 from another location displayed on a screen, and/or uploading a data element 102 from another device. In some examples, the interfaces 300-302 may be adapted to enable one or more of the aforementioned processes for uploading a data element 102. In some examples, the interface 300 may be displayed based on user selection of the button 208 within interface 200. In some examples, the interface 302 may be displayed based on user selection of the button 208 within interface 204.

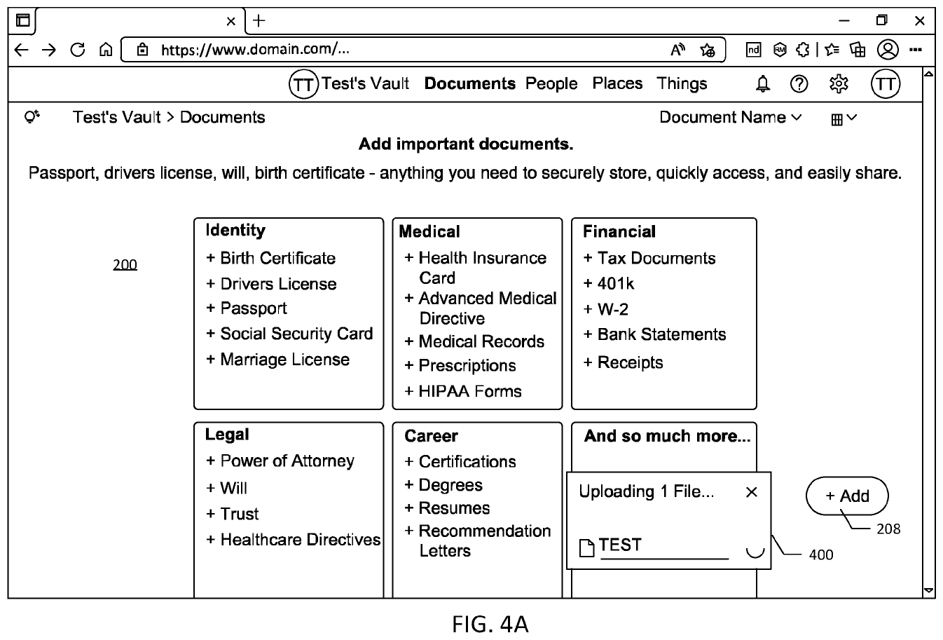

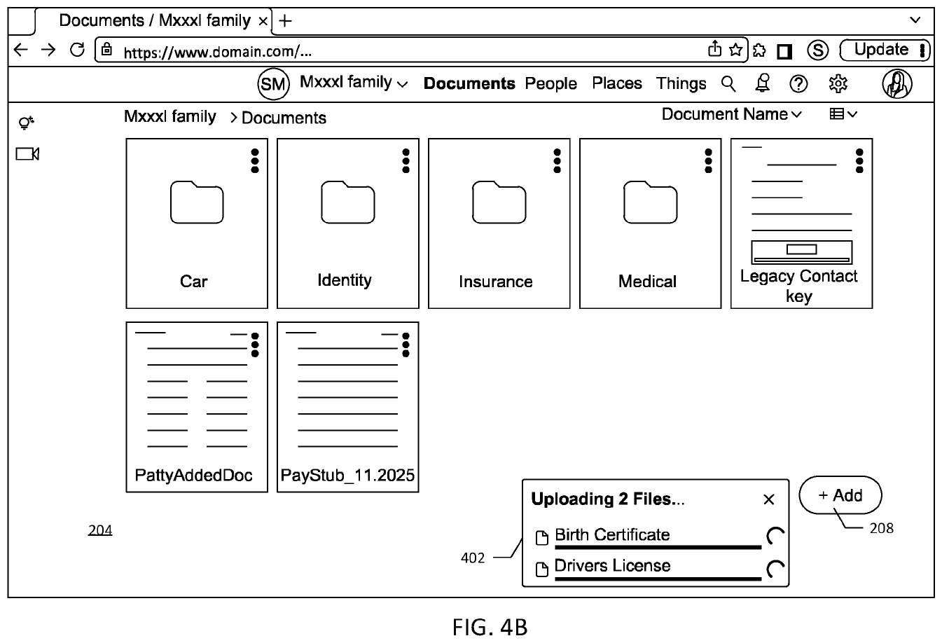

Once a document data element 102a (e.g., “Test”) is selected, the flexible referential data structure may display a window 400 as shown in FIG. 4A. The window 400 may identify the upload and/or upload progress of the document data element 102a via interface 200. Alternatively, as shown in FIG. 4B, a window 402 may identify the upload and/or upload progress of one or more document data elements 102a (e.g., birth certificate and drivers license) via interface 204.

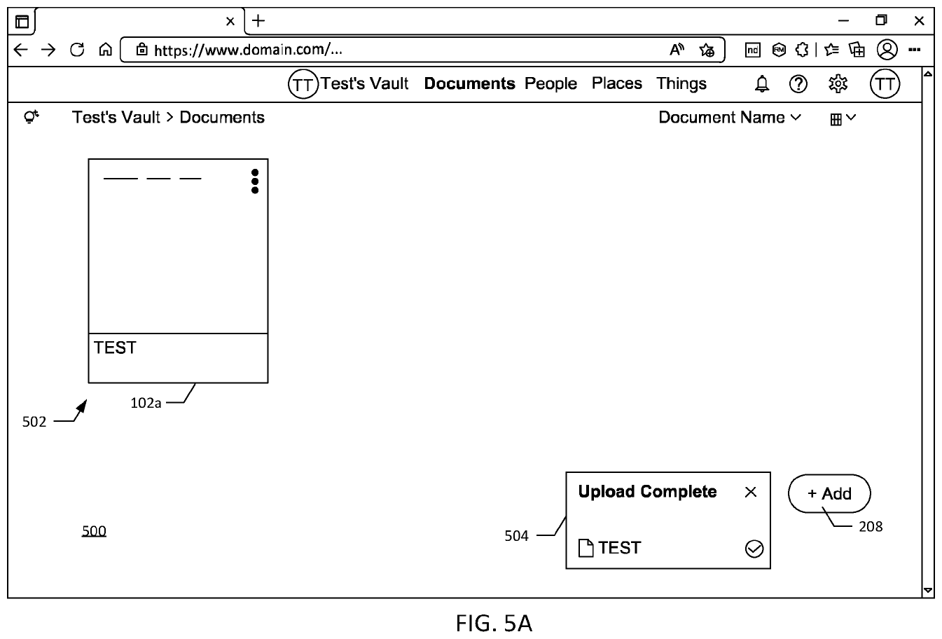

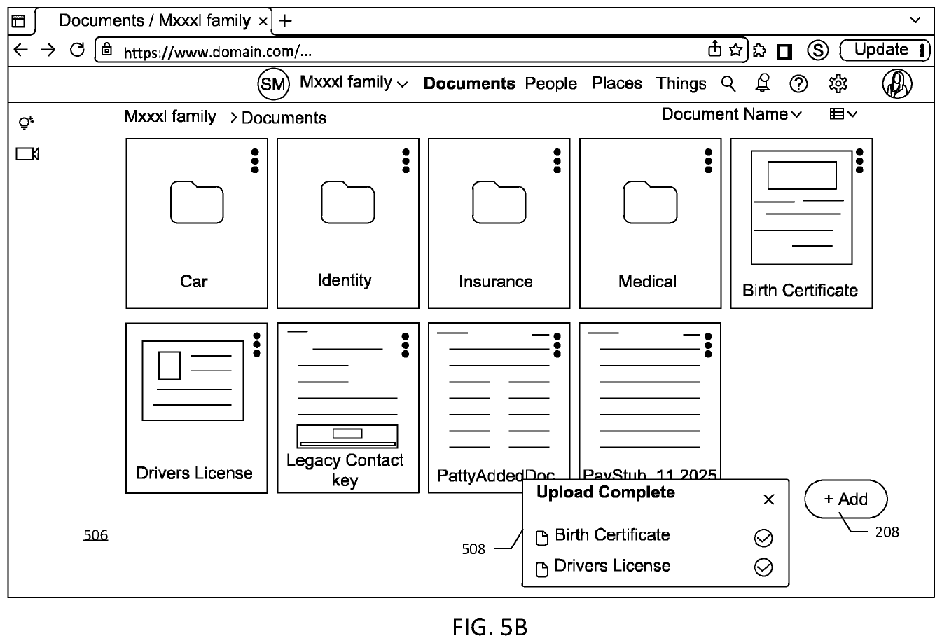

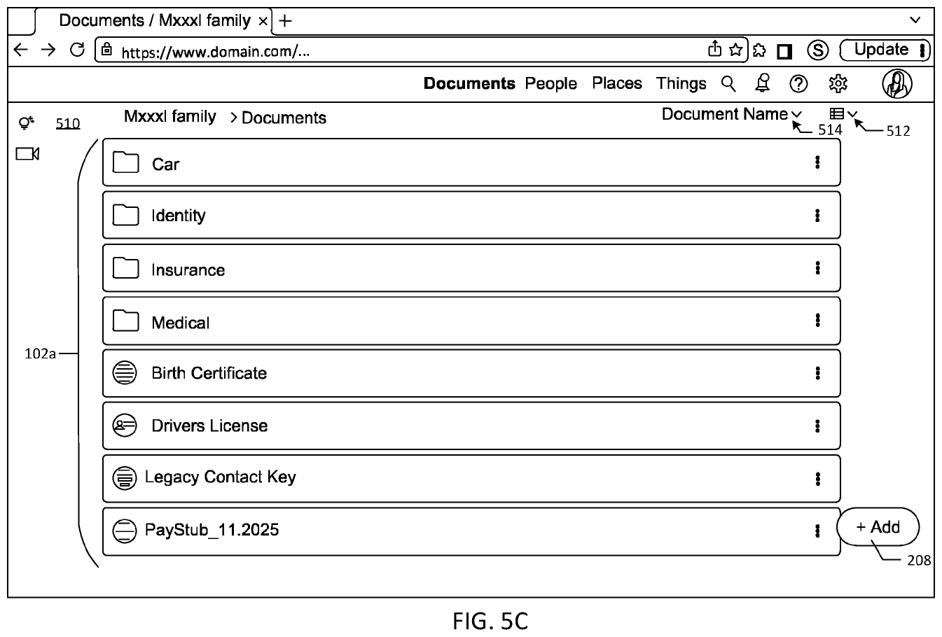

Once uploaded, the flexible referential data structure may display an interface 500, as shown in FIG. 5A. The interface 500 may display an instance 502 of the uploaded document data element 102a. In some examples, the interface 500 may display a window 504 indicating that the upload is complete. In some examples, the window 504 of FIG. 5A may be a different window than the window 400 from FIG. 4A. In some examples, the window 504 of FIG. 5A may be an updated version of the window 400 from FIG. 4A. In some examples, the interface 500 may display all instances of document data elements 102a within the flexible referential data structure. In some examples, the interface 500 may display the most recently uploaded document data element 102a instance.

Alternatively, as shown in FIG. 5B, an interface 506 may display a window 508 indicating that an upload of one or more document data elements 102a (e.g., birth certificate and drivers license) from FIG. 4B are complete. In some examples, the window 508 of FIG. 5B may be a different window than the window 402 from FIG. 4B. In some examples, the window 508 of FIG. 5B may be an updated version of the window 402 from FIG. 4B. In some examples, the interface 506 may display all instances of document data elements 102a within the flexible referential data structure, including the most recently uploaded document data elements 102a.

As shown in FIG. 5C, an instruction to change the organization of interface 506 may be received (e.g., by a user) and the flexible referential data structure may display interface 510. Interface 510 may display the various document data elements 102a in a column format, rather than a row format. In some examples, the orientation of the document data elements 102a may be changed via a view button 512. In some examples, the sorting of the document data elements 102a may be changed via a sort button 514 (e.g., ascending/descending by data element name, upload date, expiration date, number of people with which the data element is shared, etc.).

In some examples, the button 208 may persist as an overlay so that the button 208 may be accessed via and/or in connection with the various interfaces described herein. In some examples, upon user selection of the button 208, the flexible referential data structure may provide recommendations of data elements to be uploaded. In some examples, the recommendations may be based on a number of questions answered by a user. In some examples, the recommendations may be based on machine learning algorithms that use anonymized user data from one or more users relating to what was added to one or more other flexible referential data structures as a learning set, in order to predict additional items to be added to a current user's flexible referential data structure. In some examples, recommendations may be generated based on items added before and/or after a recommendation.

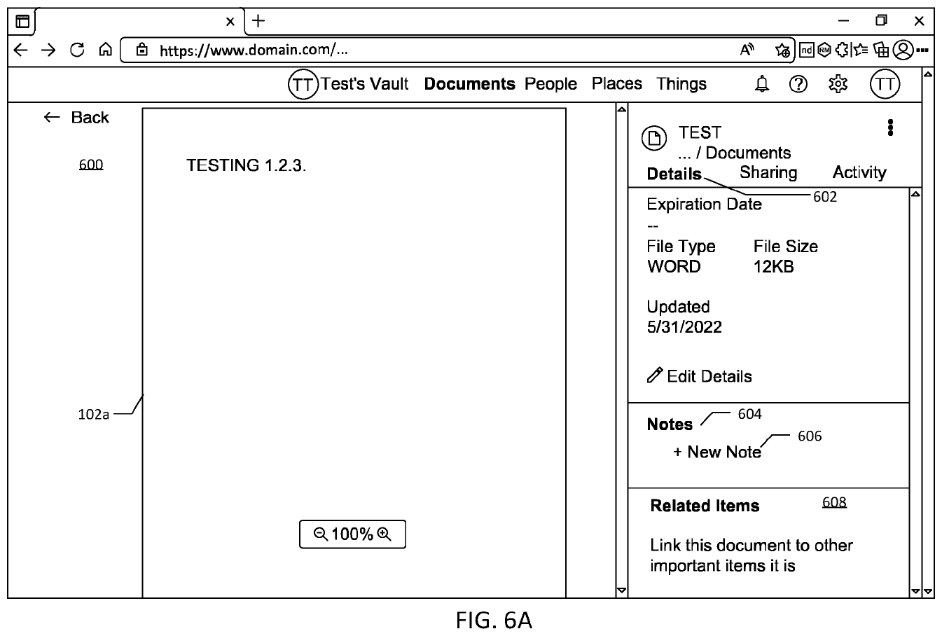

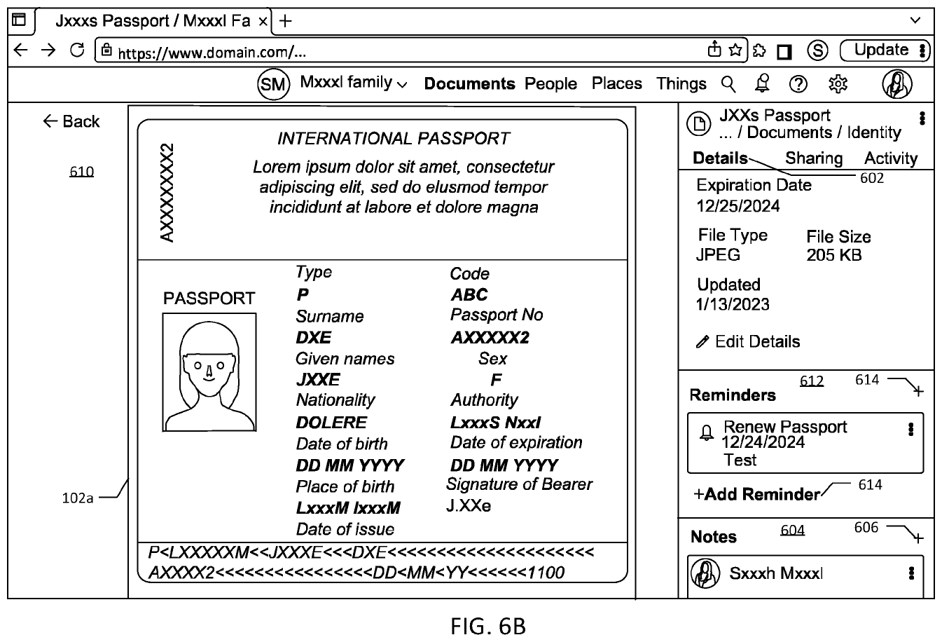

As shown in FIG. 6A, the flexible referential data structure may display an example document data element 102a in an interface 600. Other data elements 102 as described herein (e.g., people, places, things) may be displayed and/or viewed in a similar manner. The interface 600 may comprise a details tab 602 in which aspects of the data elements 102 may be detailed (e.g., file type, file size, last updated, expiration date, etc.). In some examples, a data element 102 may be supplemented with notes 604. The notes 604 may supplement the data element 102 in any manner. For example, narrative stories associated with the data element 102 may be written or recorded with video and uploaded to supplement the data element (e.g., stories explaining who, what, where, when, how, why, etc.). For example, textual, photographic, or videographic notes may be added to supplement the data element using a button 606. In some examples, data elements 102 may be related to other data elements 102. In some such examples, related items may be displayed within a window 608.

As illustrated in FIG. 6B, the flexible referential data structure may display an additional or alternative interface 610, which may display an example document data element 102a (e.g., a passport) in a similar manner with respect to FIG. 6A. In addition to the features discussed above with reference to FIG. 6A, the flexible referential data structure may further comprise a reminders window 612 in which reminders may be displayed and/or added to a data element. In some examples, a button 614 may be used to generate a reminder. Reminders may trigger a notification on a specific date and/or time. In some examples, the specific date and/or time may be set by user. In some examples, the specific date and/or time may be automatically set based on metadata associated with a data element (e.g., an expiration date/time, an effective date/time, a date/time associated with periodic maintenance, a date/time in an electronic calendar associated with the data element 102, etc.). In some examples, the reminders may be reoccurring. In some examples, the reminders may be a single occurrence. In some examples, the flexible referential data structure may enable various types of notification types such as, for example, e-mails, push notifications, in-app notifications, multimedia messaging service communications, audio notifications (e.g., alarms, pre-recorded messages, automated cellular communications, etc.). In some examples, a notification type may default to one or more of the foregoing. In some examples, the notification type(s) may be user-selected.

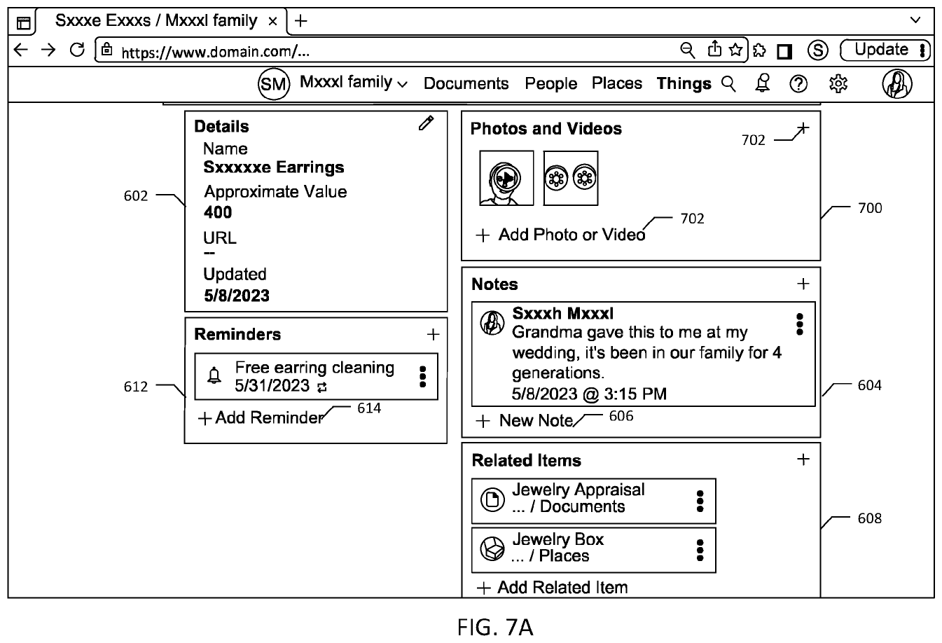

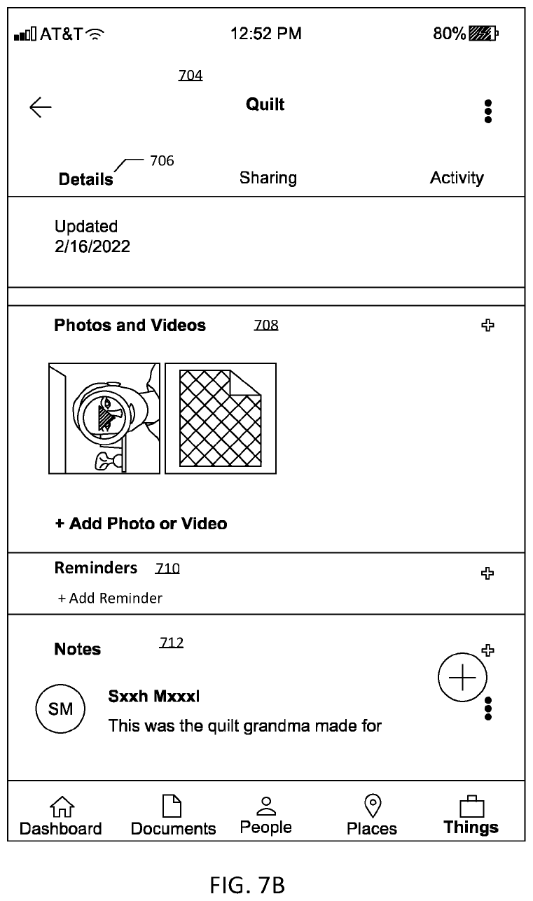

In some examples, photos and videos may be added to a data element 102 in a separate window 700, as shown in FIG. 7A. The flexible referential data structure may be updated with photos and videos via a separate button 702 for adding photos or videos. In the illustrated example of FIG. 7A, the details tab 602, notes 604, related items window 608, reminders window 612, and/or respective buttons 606 and 614 may also be displayed for user interaction.

As shown in FIG. 7B, the flexible referential data structure may display a mobile interface 704 with similar features as set forth with respect to FIG. 7A. In some examples, due to limited screen sizes associated with mobile devices, one or more features may not be presented on a mobile device screen, and the interface 704 may be scrolled or otherwise interacted with (e.g., by a user) to display additional features. For example, interface 704 may include a details tab 706, a window 708 for uploading photos and videos, a window 710 for adding reminders, and a window 712 for adding notes. In some examples, a related items window (not shown) may be displayed upon scrolling through interface 704.

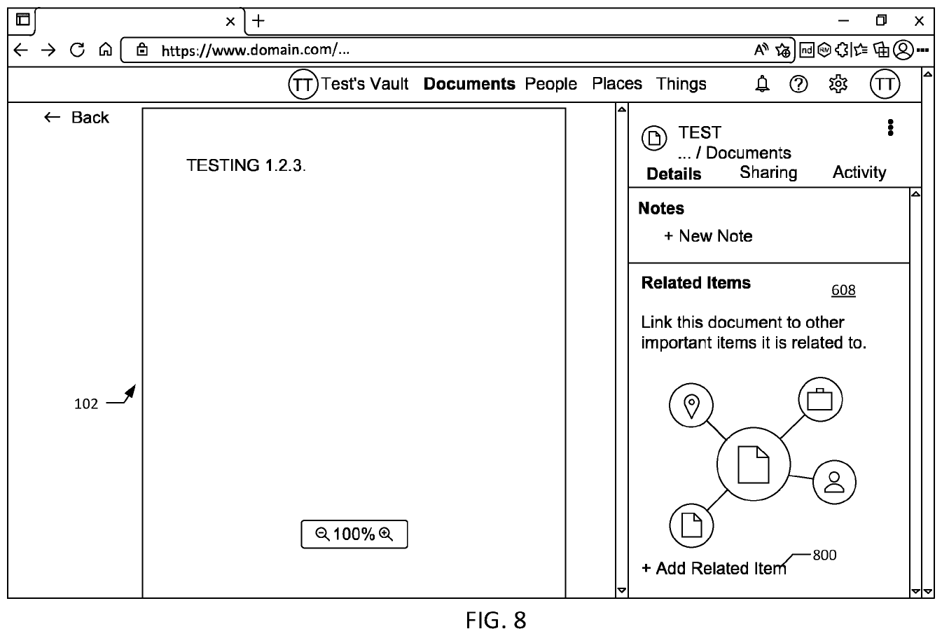

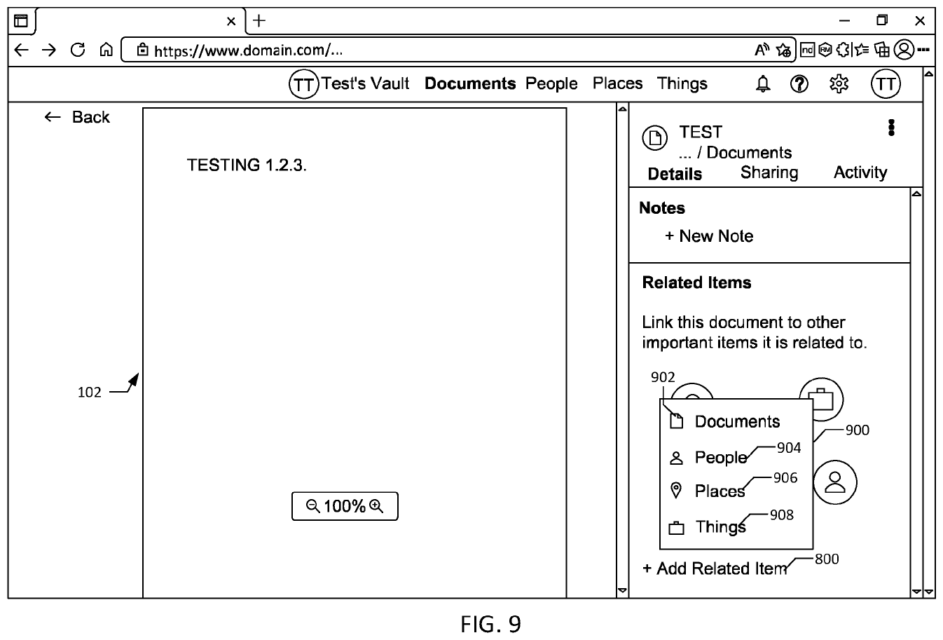

The example related items window 608 is further described with reference to FIGS. 8-14. In some examples, the related items window 608 may include an add related item button 800 to initiate the relating/linking process. FIG. 9 illustrates that, in response to user selection of the add related item button 800, a window 900 may be displayed illustrating a document data elements button 902, a people data elements button 904, a places data elements button 906, and things data elements button 908, which upon user selection may enable various data elements 102a-d to be related to the data element 102 being viewed.

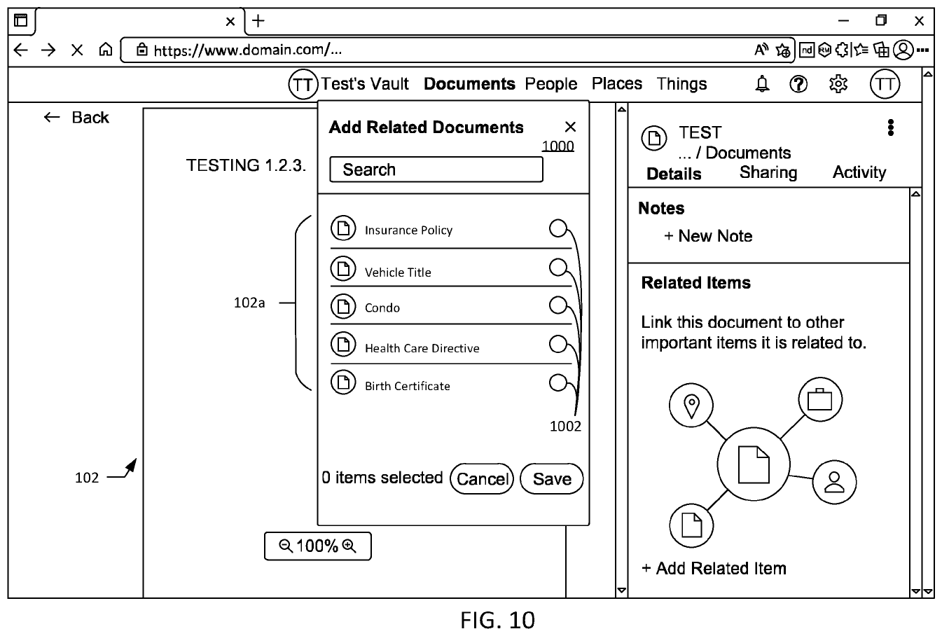

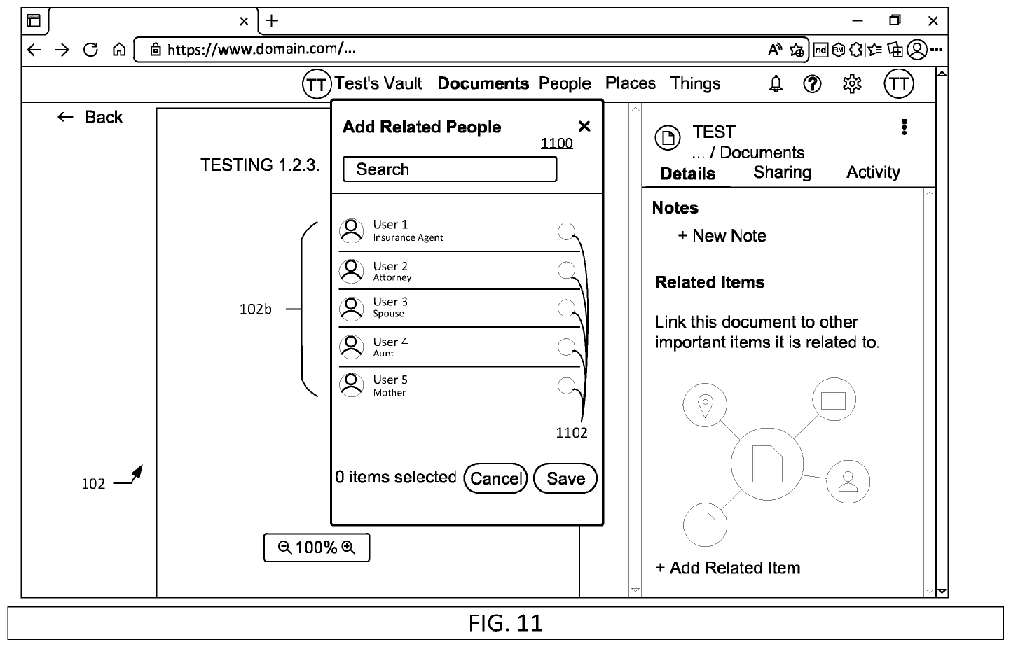

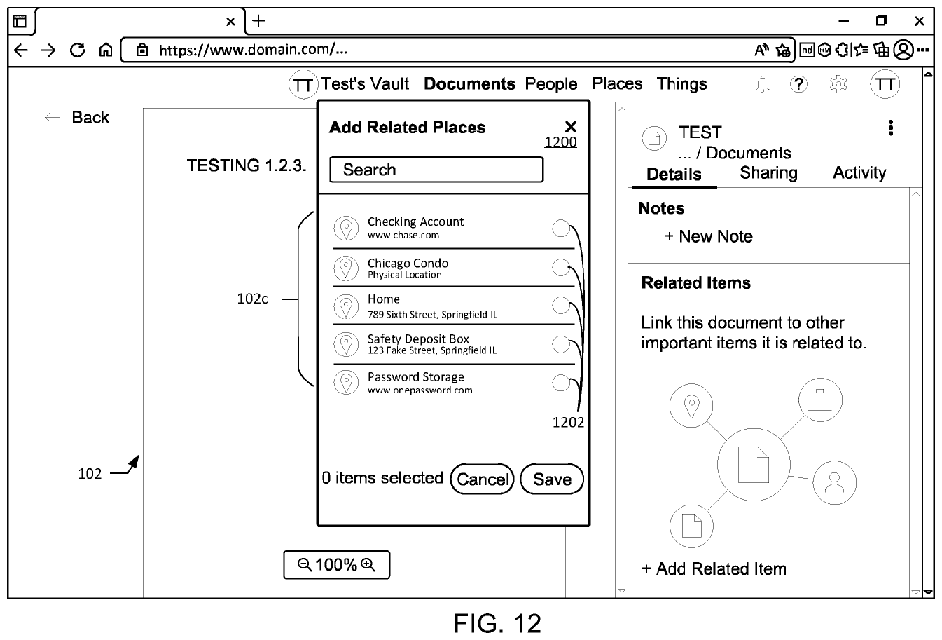

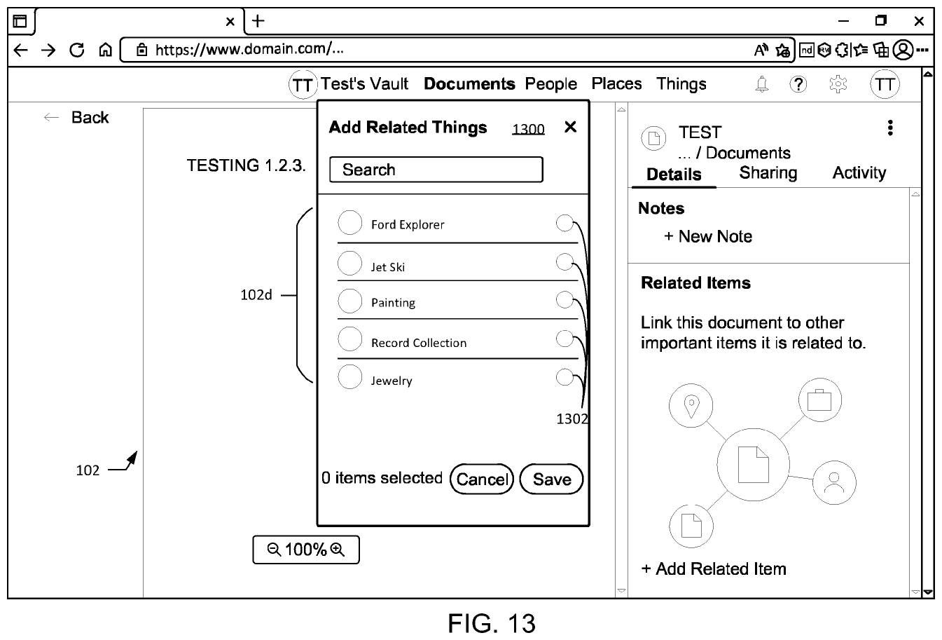

As shown in FIG. 10, upon user selection of the document data elements button 902, an add related documents window 1000 may be displayed. Window 1000 may enable data elements 102 to be related or otherwise linked to one or more document data elements 102a (e.g., insurance policy, vehicle title, condominium, health care directive, birth certificate, etc.) via selection of one or more icons 1002. As shown in FIG. 11, upon user selection of the people data elements button 904, an add related people window 1100 may be displayed. Window 1100 may enable data elements 102 to be related or otherwise linked to one or more people data elements 102b (e.g., insurance agent, attorney, spouse, aunt, mother, etc.) via selection of one or more icons 1102. As shown in FIG. 12, upon user selection of the places data elements button 906, an add related places window 1200 may be displayed. Window 1200 may enable data elements 102 to be related or otherwise linked to one or more places data elements 102c (e.g., checking account, condominium address, home address, safety deposit box, password storage, etc.) via selection of one or more icons 1202. As shown in FIG. 13, upon user selection of the things data elements button 908, an add related things window 1300 may be displayed. Window 1300 may enable data elements 102 to be related or otherwise linked to one or more things data elements 102d (e.g., Ford® Explorer, jet ski, painting, record collection, jewelry, etc.) via selection of one or more icons 1302. In some examples, the flexible referential data structure may enable any document, person, place, or thing to be related or otherwise linked to any other document person, place, or thing in limitless combinations and lengths of relation. For example, a data element may be linked to one or more other documents, one or more other people, and/or one or more other things that a user has access to (e.g., via sharing) or has otherwise uploaded to their own flexible referential data structure. In some examples, each data element 102 may be linked or related to one or more other documents, one or more other people, and/or one or more other things, thereby creating a network of related data elements 102.

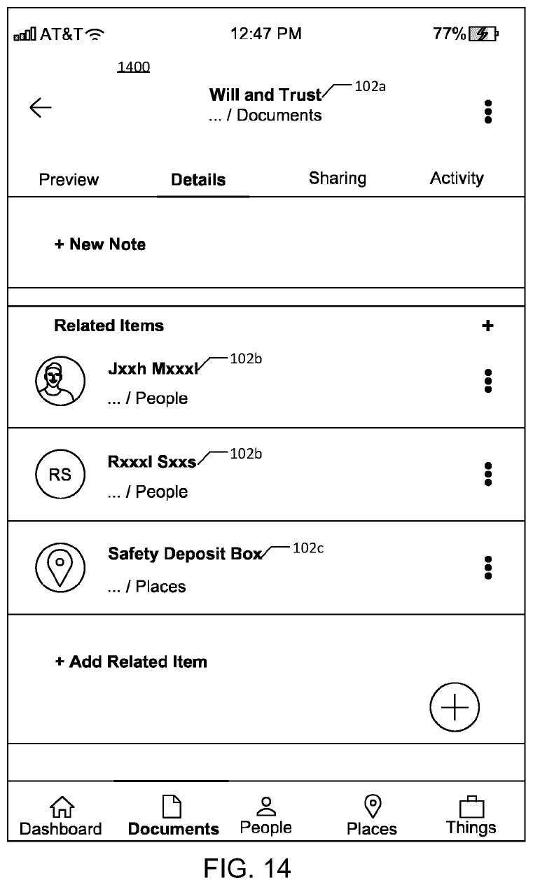

FIG. 14 illustrates an exemplary interface 1400 illustrating an example document data element 102a (e.g., Will and Trust) that may be linked to two people data elements 102b (e.g., Jxxh Mxxxl and Rxxxl Sxxs) and a places data element 102c (e.g., Safety Deposit Box). Such relations may be important to enable the flexible referential data structure to, for example, identify the people and location associated with a will and trust such as for survivors. In such an example, not only do the flexible referential data structures disclosed herein store digital versions of documents uploaded thereto, but also important supplemental information tied to physical versions of such documents and the people involved with such documents (e.g., attorneys, spouses, surviving childing, etc.).

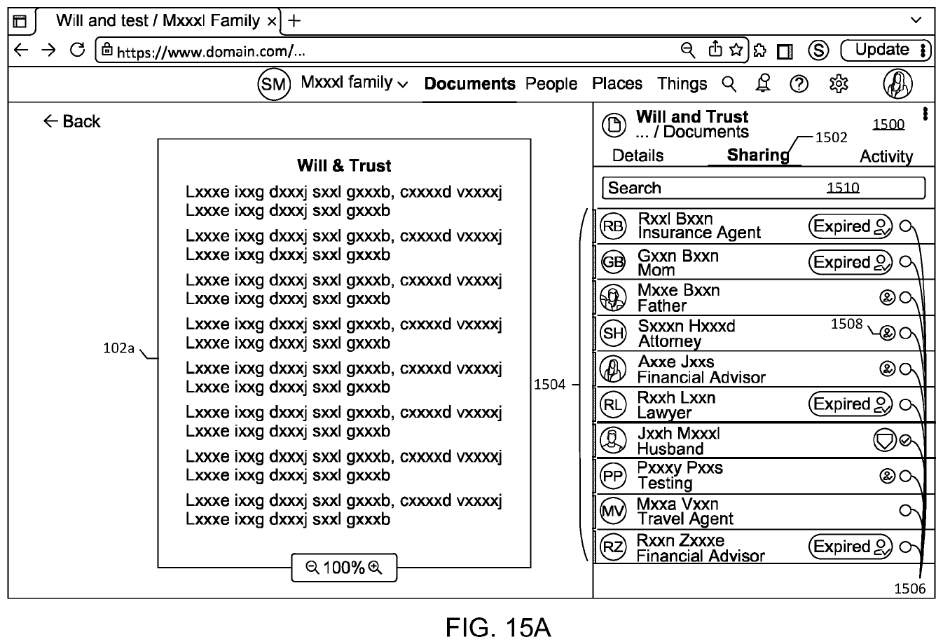

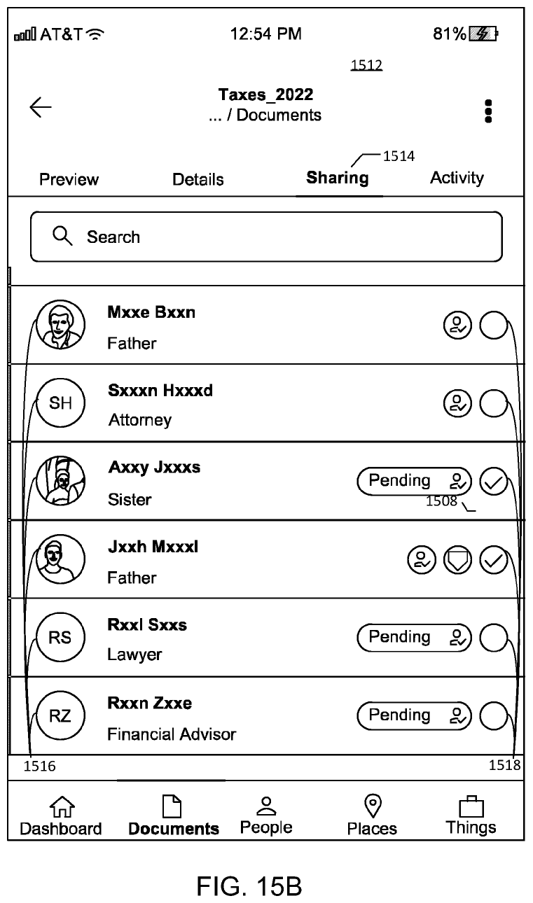

As shown in FIG. 15A, the flexible referential data structure may enable data elements, such as the example document data element 102a (e.g., will and trust), to be shared between users. To that end, the flexible referential data structure may display an interface 1500. The example interface 1500 may include a sharing tab 1502. Upon selection of the sharing tab 1502, the flexible referential data structure may display a list of known users 1504 and icons 1506. In some examples, the list of known users 1504 includes users that have received an invitation from the account owner to join the owner's flexible referential data structure. In some such examples, such an invitation may first be sent to a user before a data element may be shared with that user. In some examples, the list of known users 1504 includes users that do not have his or her own account associated with a flexible referential data structure as disclosed herein (e.g., users imported from a third-party contact list). In some examples, upon selection of the user from the list of known users 1504, the flexible referential data structure may provide the selected user with a link to set up an account, which upon activation, enables the sharing of access (e.g., viewing) to the data element 102a. In some examples, the flexible referential data structure may distinguish people that have been provided access and either have accounts or have been invited to set up an account from other people that have not been invited for access. In some such examples, a visual indicator 1508 may be used to distinguish between these types of people.

In some examples, selection of a user via one of the one or more icons 1506 shares access (e.g., viewing) with that user. In some examples, the data elements may be shared without input from the selected user. In some examples, the one or more icons 1506 may be altered (e.g., include a checkmark or other indication therein) to indicate that a data element has been shared with a user. For example, for the example document data element 102a (e.g., will and trust), FIG. 15A illustrates that that data element 102a has been shared or selected to be shared with Jxxh Mxxxl, the account owner's husband. In some examples, the list of known users 1504 may be viewed to see which other users have access to a particular data element 102. In some examples, a search window 1510 may be presented in association with the list of known users 1504. The search window 1510 may be used to refine the list of known users 1504 (e.g., search for a particular user by name, search for users based on profession, search for users based on location, search for users with access to a data element 102, search for users without access to a data element 102, etc.). In some examples, selecting an already selected icon of the one or more icons 1506 removes access to (e.g., un-shares) the data element 102.

As shown in FIG. 15B, the flexible referential data structure may display a mobile interface 1512 with similar features as set forth with respect to FIG. 15A. For example, an example document data element 102a (e.g., taxes) may be shared with one or more users via interface 1512. The example interface 1512 may include a sharing tab 1514. Upon selection of the sharing tab 1514, the flexible referential data structure may display a list of known users 1516 and icons 1518. A data element 102 may be shared with one or more users from the list of known users 1516 in a similar way as described with reference to FIG. 15A.

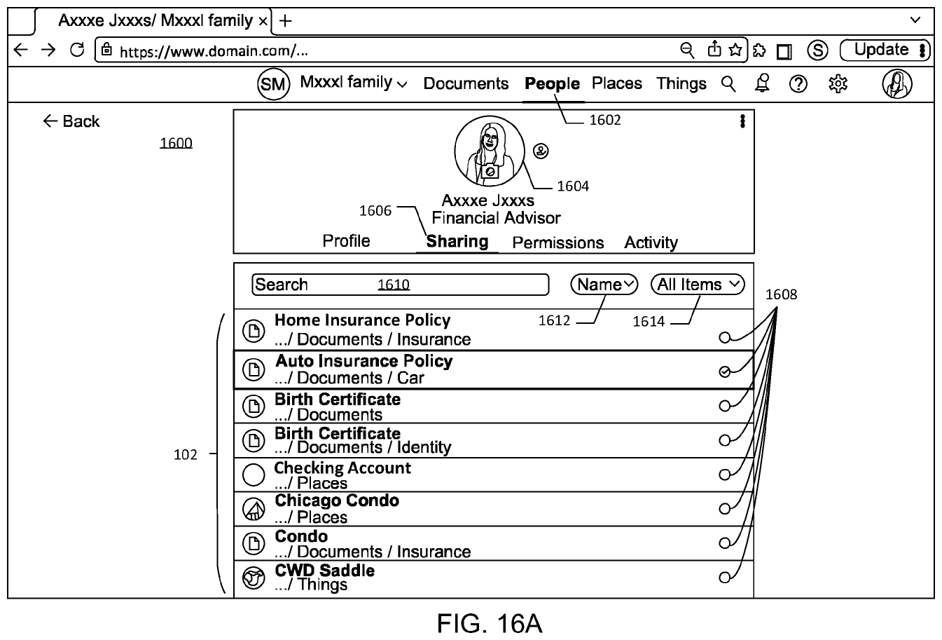

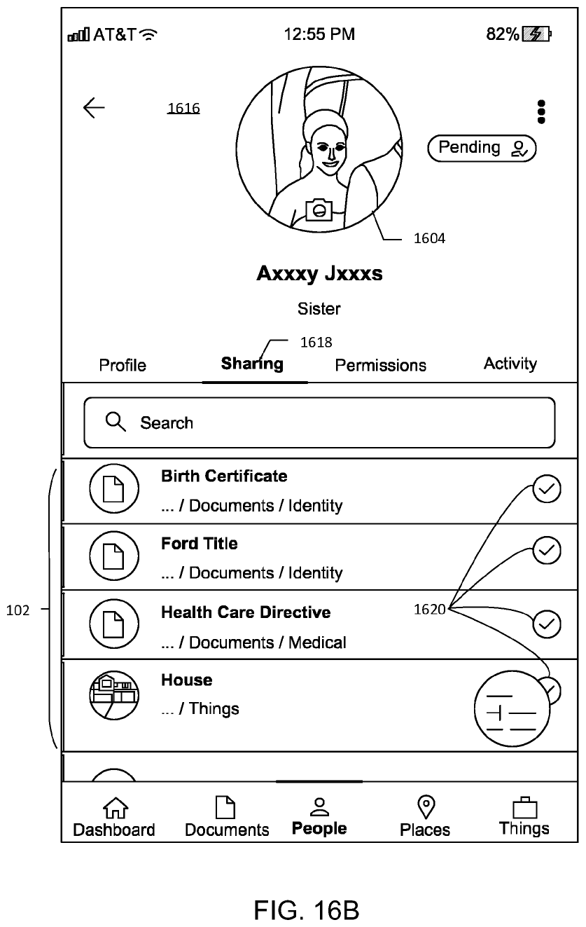

FIGS. 15A-15B illustrate how an account owner can share a data element with one or more other users. Additionally or alternatively, as shown in FIGS. 16A-16B, an account owner can share one or more data elements with one specific user. Thus, in some examples, the flexible referential data structures may enable multiple ways to share data elements. Not only may a user look at each data element individually to see with whom that data element has been shared (e.g., as shown and described with respect to FIGS. 15A-15B), but also a user may look at a particular person and see which data elements have been shared with that person (e.g., as shown and described with respect to FIGS. 16A-16B).

Turning to FIG. 16A, the flexible referential data structure may display an interface 1600 with a people tab 1602. Upon selection of a particular user 1604 under the people tab 1602, the flexible referential data structure may display a sharing tab 1606. The sharing tab 1606 may enable for display a list of one or more data elements 102 that are associated with the account owner and are available to be shared. In some examples, the list of one or more data elements 102 may be associated with one or more icons 1608 that may be selected to enable a corresponding data element 102 to be shared with the selected user 1604. For example, FIG. 16A illustrates that that an example document data element 102a (e.g., Auto Insurance Policy) has been shared or selected to be shared with the selected user 1604. In some examples, the list of one or more data elements 102 may be viewed to see which data elements have been shared with the selected user 1604. In some examples, a search window 1610 may be presented in association with the list of one or more data elements 102. The search window 1610 may be used to refine the list of one or more data elements 102 (e.g., search for a particular data element 102 by name, search for data elements 102 based on type of data element, search for data elements 102 that have been shared, search for data elements 102 that have not been shared, etc.). In some examples, selecting an already selected icon of the one or more icons 1608 removes access to (e.g., un-shares) the data element 102. In some examples, a date associated with when the particular person last viewed or accessed a data element may be displayed adjacent that data element in the list of data elements. In some examples, the interface 1600 may include a sort option 1612, which may enable a user to organize the list of data elements (e.g., by name, by date added, or by date last viewed, in ascending or descending order). In some examples, the interface 1600 may include a filter option 1614, which may enable a user to identify all or subsets of data elements from the list of data elements (e.g., all data elements, data elements already shared with that particular person, data elements already shared with any person, recommended data elements to share, data elements that have not or should not be shared, etc.).

As shown in FIG. 16B, the flexible referential data structure may display a mobile interface 1616 with similar features as set forth with respect to FIG. 16A. For example, one or more data elements 102 may be shared with the selected user 1604. The example interface 1616 may include a sharing tab 1618. Upon selection of the sharing tab 1618, the flexible referential data structure may display a one or more data elements 102 and icons 1620. One or more data elements 102 may be shared with the selected user 1604 in a similar way as described with reference to FIG. 16A. As shown in FIGS. 16A-16B, the flexible referential data structure may enable various data elements 102 to be shared efficiently with a single person via a people data element sharing feature. In some such examples, multiple data elements 102 may be shared with a single person.

In some examples, in response to a user sharing a data element 102 with another user, the flexible referential data structure may automate creation of a reminder. The reminder may be periodic (e.g., every 6 months) and may serve as a notification to a user to confirm the sharing of a particular data element with one or more users should still be shared with one or more of the one or more users. In some examples, the reminder may be displayed in any interface described herein (e.g., interface 100) in accordance with the reminder's frequency. In some examples, reminders may be applicable to any data elements 102. In some examples, reminders may be specific to a particular user. For example, in response to a first user sharing a data element 102 with a second user, the flexible referential data structure may automatically create a reminder associated with the second user. In some such examples, the reminder may periodically notify the first user to verify whether one or more of the data elements 102 that have been shared with the second user should still be shared with the second user. In some examples, reminders may be specific to a connection between a particular data element 102 and a particular user. For example, in response to a first user sharing a data element 102 with a second user, the flexible referential data structure may automatically create a reminder associated with both the second user and the shared data element 102. In some such examples, the reminder may periodically notify the first user to verify that the specifically shared data element 102 that triggered the reminder should still be shared with the second user. In some examples, the frequency of a reminder may be set by the user. In some examples, the user (e.g., a vault owner or co-owner) may pause or otherwise delete a reminder.

In some examples, a user may only have data elements shared therewith, without being granted permissions to add, edit, or delete the data elements (e.g., granted viewing access only). In some examples, a user that has been provided shared access with a data element may only view the related or otherwise linked data elements that that user also has been provided shared access to. For example, if the document data element 102a (e.g., will and trust) shown in FIG. 14 is shared with a first user, but that first user has not been provided shared access to a linked places data element 102c (e.g., the safety deposit box), the first user would be unaware of the existence of linked places data element 102c (e.g., the safety deposit box or its relation or otherwise linkage to the will and trust.

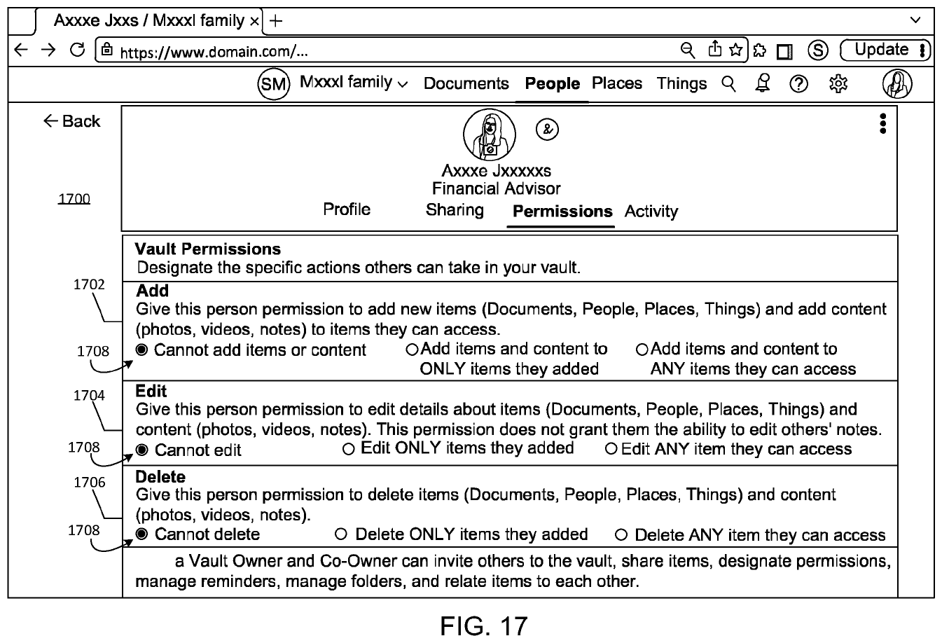

As shown in FIG. 17, various permissions may be set for users of a flexible referential data structure. The flexible referential data structure may display an interface 1700 with various permissions that may be set. In some examples, the interface 1700 may comprise an add permission 1702, an edit permission 1704, and a delete permission 1706. In some examples, each of the add permission 1702, edit permission 1704, and delete permission 1706 may have multiple levels of permissions that may be selectable via one or more icons 1708. For example, a first level of permission may be that a user cannot add, edit or delete; a second level of permission may be that a user can only add, edit, or delete what that user has added; and a third level of permission may be that a user can add, edit, or delete anything to which they have access. In some examples, a user may be granted certain permissions such as adding, editing, and deleting abilities separate from the enabled sharing. In some examples, the flexible referential data structure may enable intricate sharing and permissions to not only maintain references between various data structures but also limit exposure to such references. In some examples, related or otherwise linked information may be subsequently unrelated or otherwise unlinked. In some examples, shared information may be subsequently unshared. In some examples, permissions may be subsequently revoked.

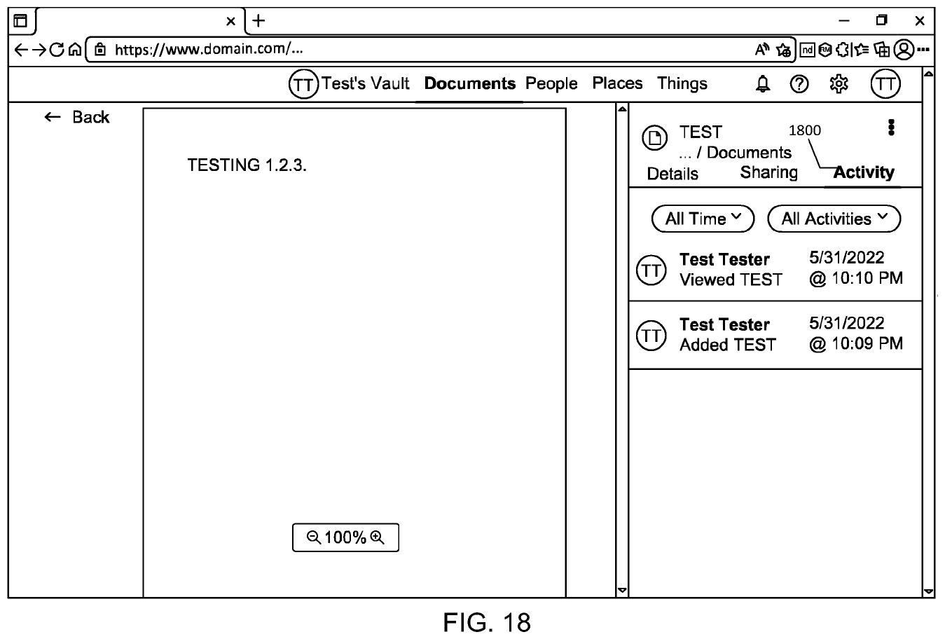

The flexible referential data structure may track and display activity associated with the flexible referential data structure such as viewing, editing, and/or sharing of data elements in an activity tab 1800 as shown in FIG. 18. In some examples, the activity may be viewable only to the account owner of an account with which the flexible referential data structures are associated. In some examples, the activity may be viewable to the account owner and a co-owner associated with the flexible referential data structure.

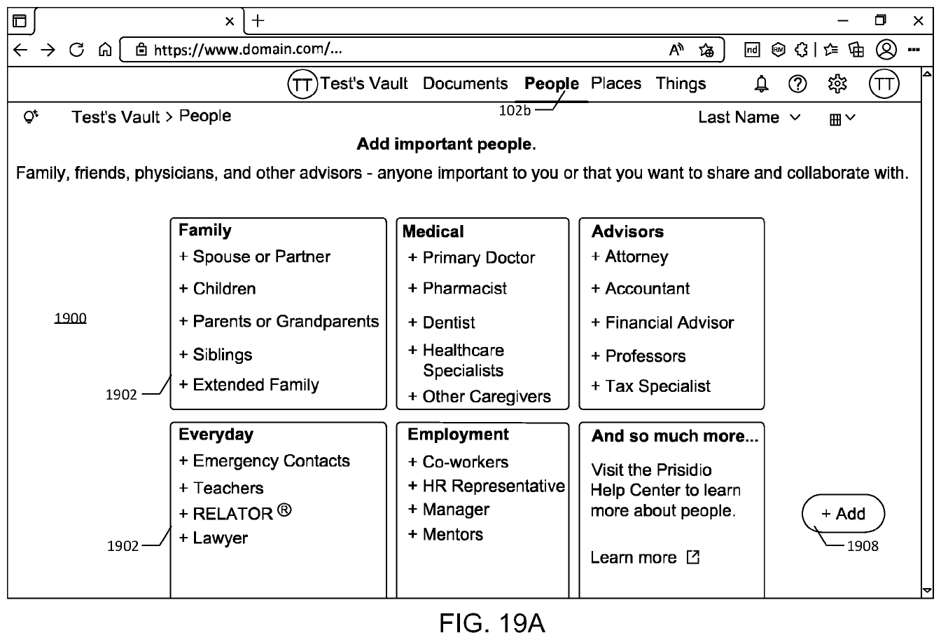

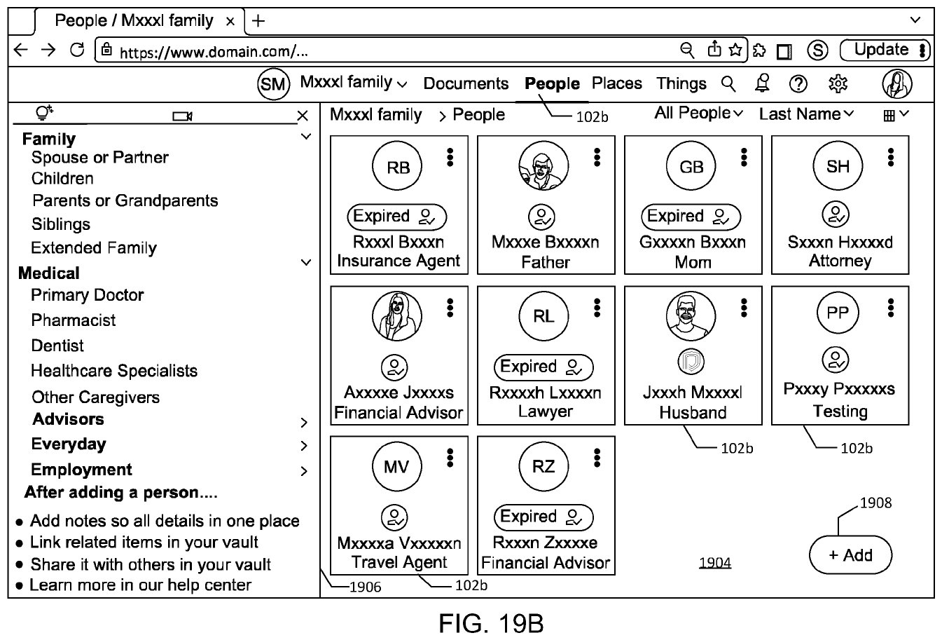

As shown in FIG. 19A, the people data elements 102b may be manipulated in an interface 1900. For example, interface 1900 may display and/or identify the various people data elements 102b already associated with the flexible referential data structure. The interface 1900 may enable a user to edit, share, or delete such existing people data elements 102b. The interface 1900 may also enable additional people data elements 102b to be added to the flexible referential data structure. The interface 1900 may comprise an interactive list of various types of people that may be added, shared, related, or otherwise linked to. For example, spouses or partners, children, parents, grandparents, siblings, extended family members, emergency contacts, teachers/professors, realtors, lawyers, primary doctors, pharmacists, dentists, healthcare specialists, other caregivers, co-workers, human resources (“HR”) representatives, managers, mentors, mentees, accountants, financial advisors, tax specialists, and the like may be example people to be utilized in the flexible referential data structures disclosed herein. In some examples, the interface 1900 may include separate categories 1902 of various types of people data elements 102b that may be included in the flexible referential data structures disclosed herein. In some examples, the categories 1902 may be displayed as boxes within the interface 1900, as shown in FIG. 19A.

As shown in FIG. 19B, an alternate interface 1904 may display categories 1906 in a textual hierarchy. In some examples, the interface 1900 and the alternate interface 1904 may include a button 1908, which may be a shortcut to adding instances of people data elements 102b to the flexible referential data structure via either the interface 1900 and the alternate interface 1904.

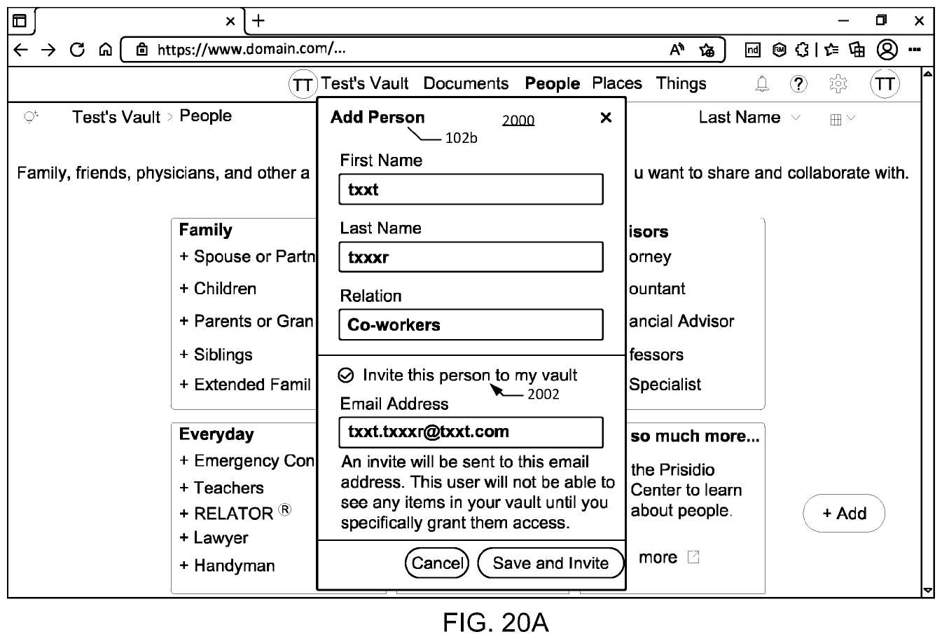

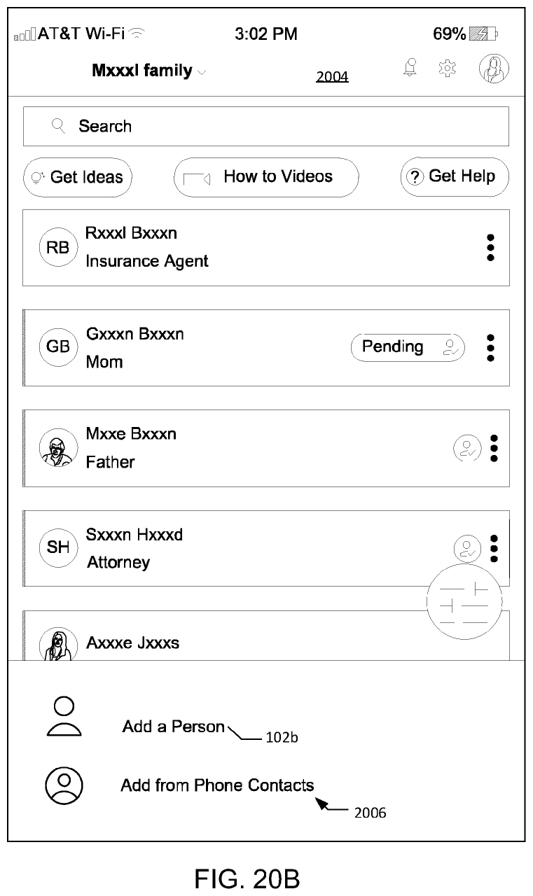

FIG. 20A illustrates an example interface 2000 for adding a people data element 102b. In some examples, interface 2000 enables user input for describing a people data element 102b (or any other data element 102), including descriptive information such as name, relation, email address, or other person identifying information. In some examples, interface 2000 includes an invitation icon 2002, which may enable an account owner to invite the person being added to the flexible referential data structure (e.g., via an automated email). FIG. 20B illustrates an alternative interface 2004 that enables adding a people data element 102b on a mobile device. In some examples, the flexible referential data structure may enable contacts from a user's mobile phone to be imported to populate the people data elements via a button 2006. In some examples, the interface 2000 may be displayed based on user selection of the button 1908 within interface 1900. In some examples, the interface 2004 may be displayed based on user selection of the button 1908 within interface 1904. Once a people data element 102b has been added, the flexible referential data structure may display an interface associated with that person, which may include the various details tabs, sharing tabs, and activity tabs as well as the photo and video window, notes window, related items window, and/or reminder windows as previously described herein with respect to other data elements. For example, FIG. 16A illustrates example interface 1600 with the sharing tab 1606 selected. However, the information entered during the adding stage may appear in a profile tab associated with that person for future reference, supplementation, editing, and/or deletion.

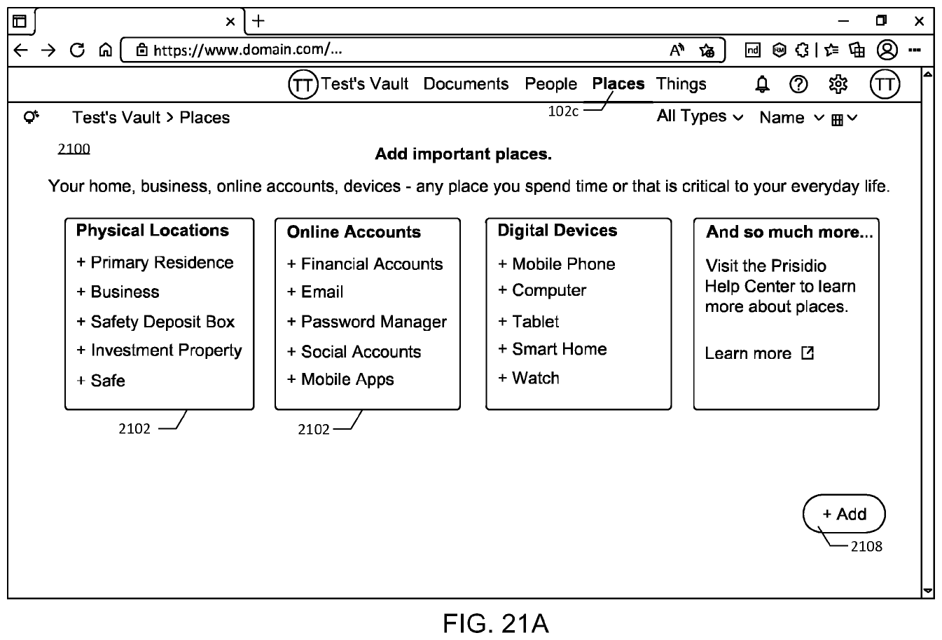

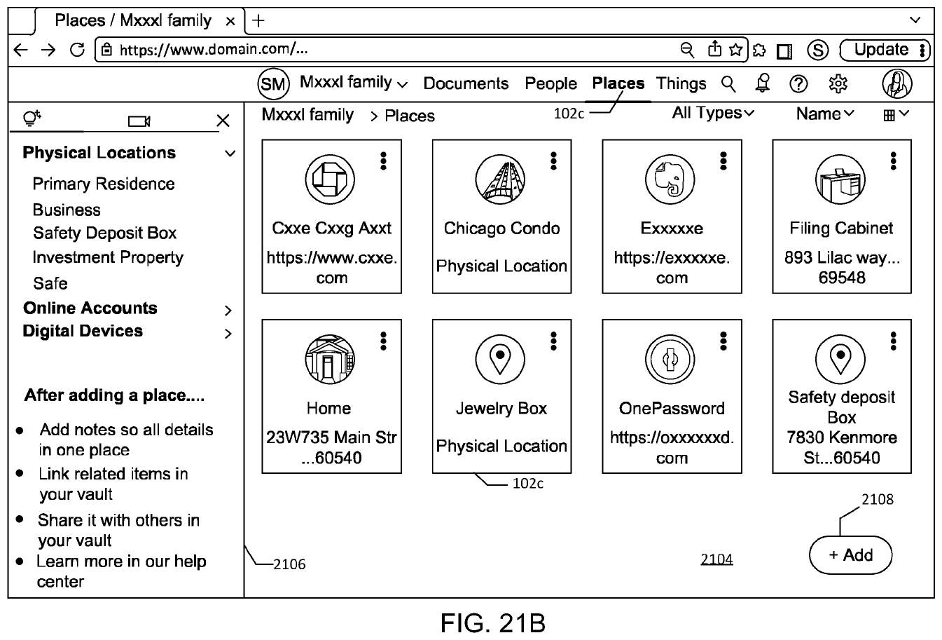

As shown in FIG. 21A, the places data elements 102c may be manipulated in an interface 2100. For example, interface 2100 may display and/or identify the various places data elements 102c already associated with the flexible referential data structure. The interface 2100 may enable a user to edit, share, or delete such existing places data elements 102c. The interface 2100 may also enable additional places data elements 102c to be added to the flexible referential data structure. The interface 2100 may comprise an interactive list of various types of places (e.g., physical addresses, physical devices, digital storage locations (e.g., iCloud), digital accounts, etc.) that may be added, shared, related, or otherwise linked to. For example, primary residences, businesses, safety deposit boxes, investment properties, safes, financial accounts, emails, password managers, social media accounts, mobile applications, mobile phones, computers, tablets, crypto wallets (e.g., Coinbase), password managers (e.g., 1Password), smart homes, watches, and the like may be example places to be utilized in the flexible referential data structures disclosed herein. In some examples, the interface 2100 may include separate categories 2102 of various types of places data elements 102c that may be included in the flexible referential data structures disclosed herein. In some examples, the categories 2102 may be displayed as boxes within the interface 2100, as shown in FIG. 21A.

As shown in FIG. 21B, an alternate interface 2104 may display categories 2106 in a textual hierarchy. In some examples, the interface 2100 and the alternate interface 2104 may include a button 2108, which may be a shortcut to adding instances of places data elements 102c to the flexible referential data structure via either the interface 2100 and the alternate interface 2104.

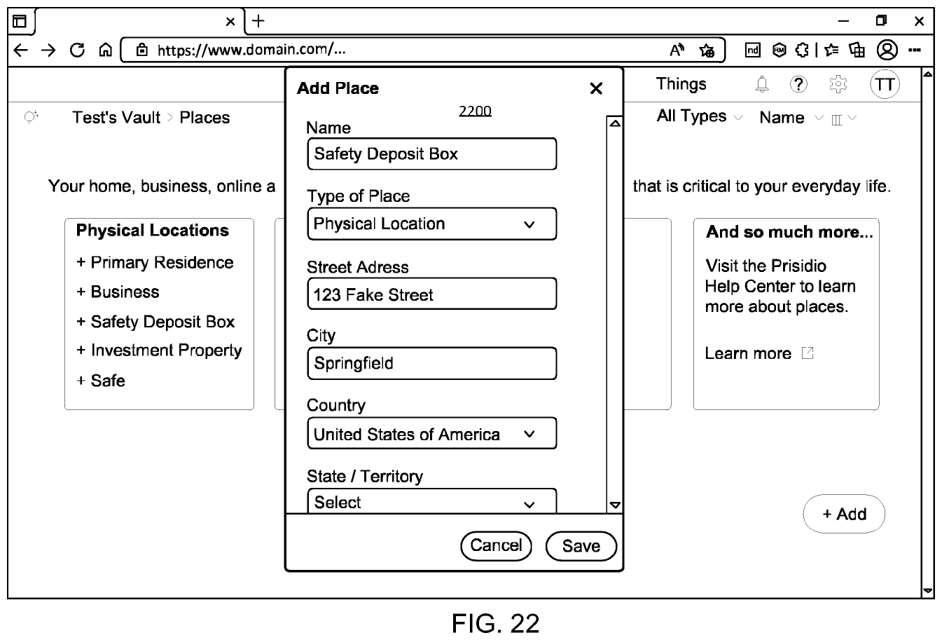

FIG. 22 illustrates an interface 2200, which may enable user input for describing a places data element 102c (or any other data element 102), including descriptive information such as name, type of place, address, or other place identifying information in a similar way as described above with reference to FIG. 20A.

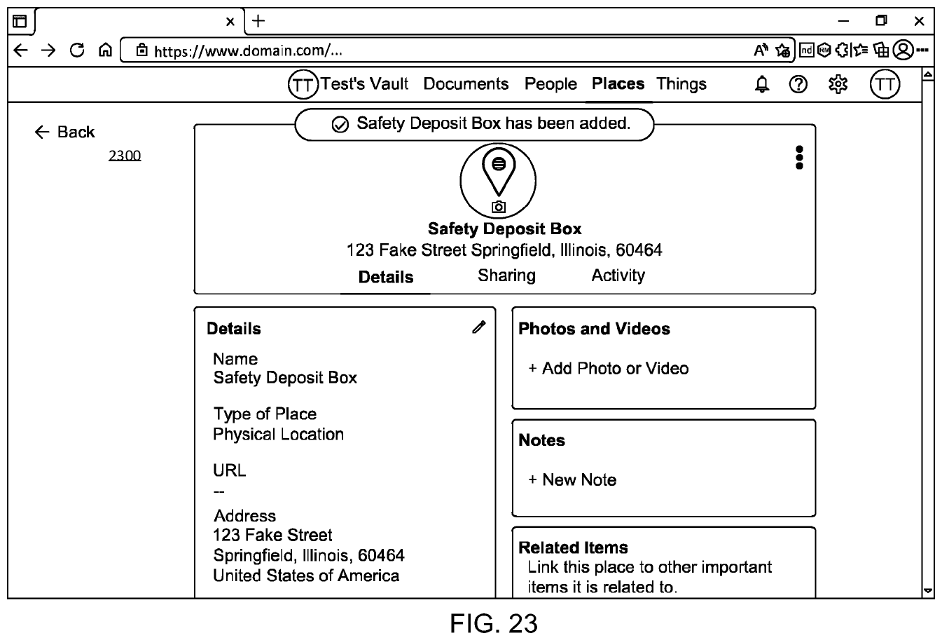

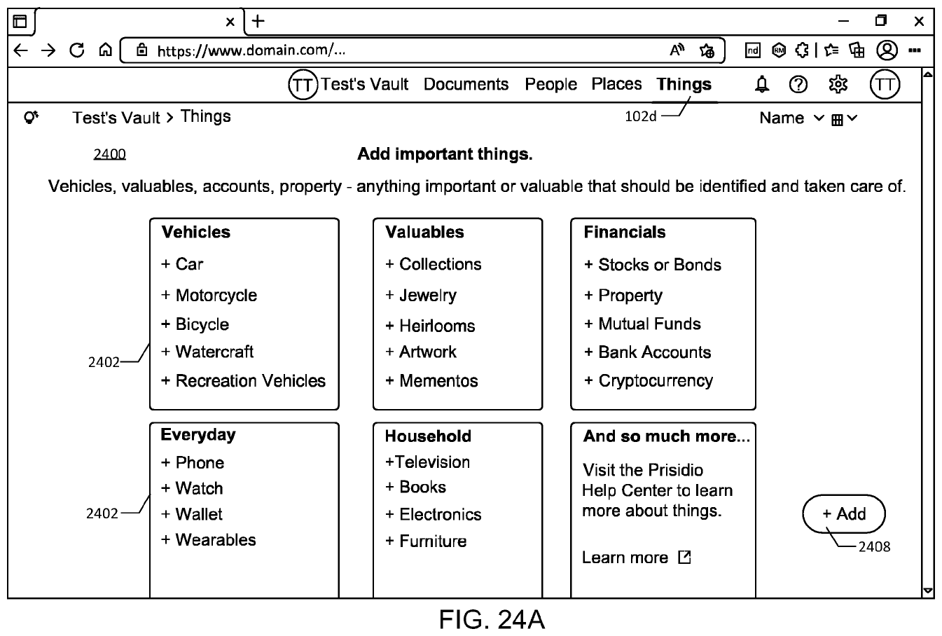

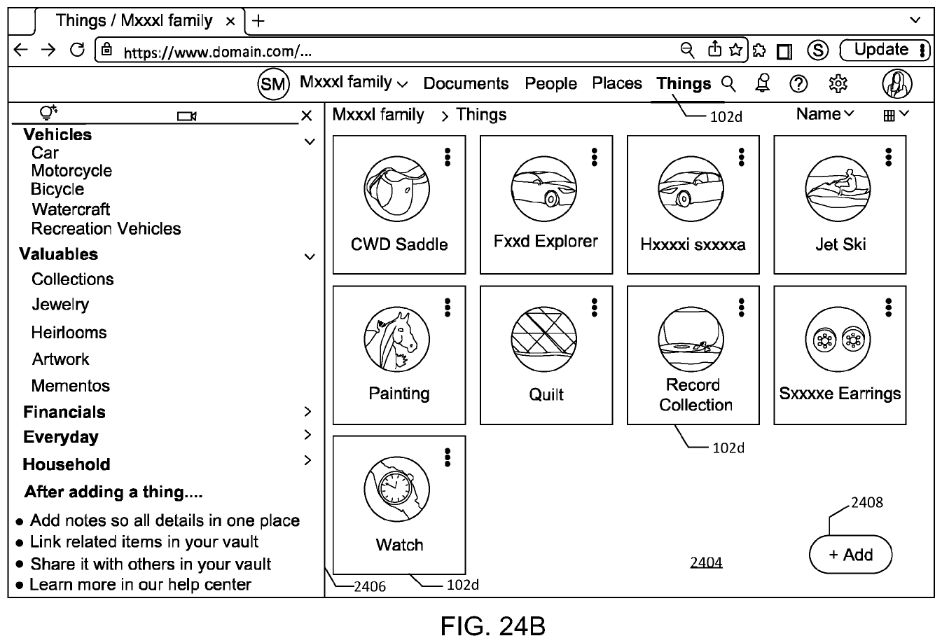

Once a places data element 102c has been added, the flexible referential data structure may display an interface 2300, as shown in FIG. 23. The interface 2300 may include the various details tabs, sharing tabs, and activity tabs as well as the photo and video window, notes window, related items window, and/or reminder windows as previously described herein with respect to other data elements. As shown in FIG. 24A, the things data elements 102d may be manipulated in an interface 2400. For example, interface 2400 may display and/or identify the various things data elements 102d already associated with the flexible referential data structure. The interface 2400 may enable a user to edit, share, or delete such existing things data elements 102d. The interface 2400 may also enable additional things data elements 102d to be added to the flexible referential data structure. The interface 2400 may comprise an interactive list of various types of things that may be added, shared, related, or otherwise linked to. For example, cars, motorcycles, bicycles, watercraft, recreational vehicles, phones, watches, wallets, wearables, collections, jewelry, heirlooms, artwork, mementos, television, books, electronics, furniture, stocks or bonds, property, mutual funds, bank accounts, cryptocurrency, and the like may be example things to be utilized in the flexible referential data structures disclosed herein. In some examples, the interface 2400 may include separate categories 2402 of various types of things data elements 102d that may be included in the flexible referential data structures disclosed herein. In some examples, the categories 2402 may be displayed as boxes within the interface 2400, as shown in FIG. 24A.

As shown in FIG. 24B, an alternate interface 2404 may display categories 2406 in a textual hierarchy. In some examples, the interface 2400 and the alternate interface 2404 may include a button 2408, which may be a shortcut to adding instances of things data elements 102d to the flexible referential data structure via either the interface 2400 and the alternate interface 2404.

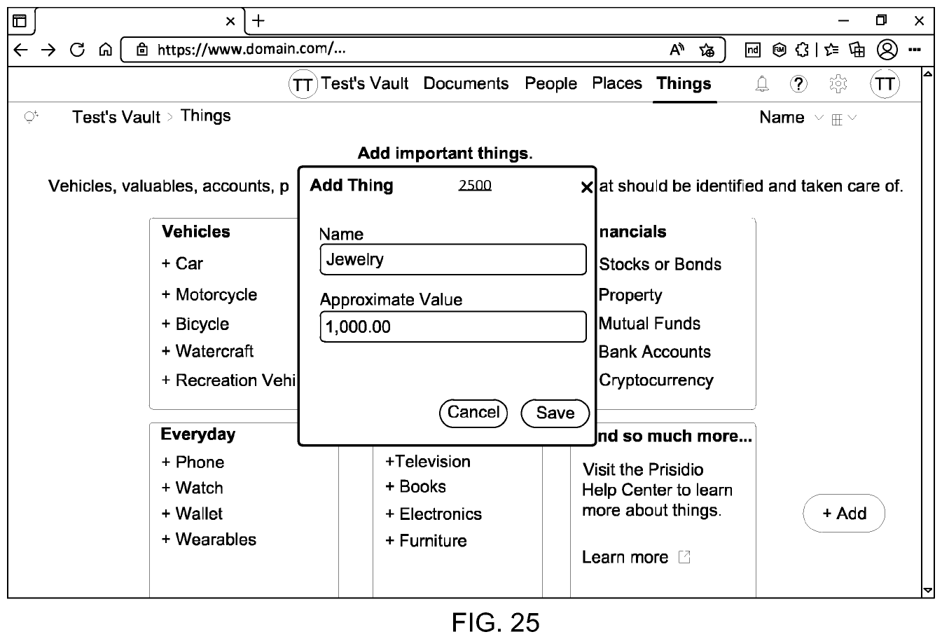

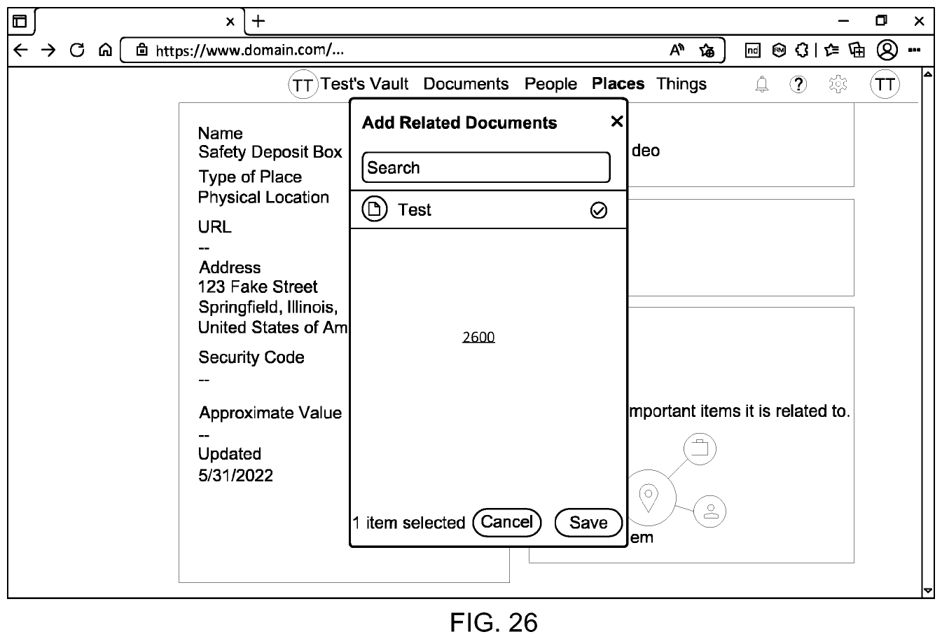

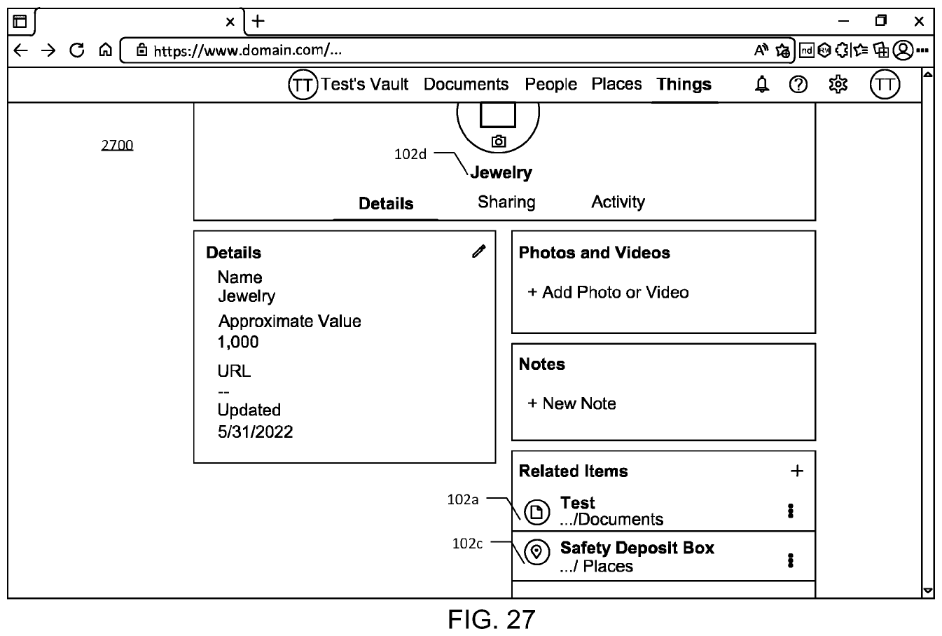

FIG. 25 illustrates an example interface 2500, which may enable user input for describing a thing data element 102d (e.g., jewelry) to be added in a similar way as described above, including descriptive information such as name, type of thing, approximate value, or other thing identifying information. FIG. 26 illustrates an example interface 2600 for adding a related document data element (e.g., TEST) to the added thing data element 102d (e.g., jewelry). Once a thing data element 102d has been added, the flexible referential data structure may display an interface 2700, as shown in FIG. 27. The interface 2700 may include the various details tabs, sharing tabs, and activity tabs as well as the photo and video window, notes window, related items window, and/or reminder windows as previously described herein with respect to other data elements. For example, as illustrated in FIG. 27, the thing data element 102d (e.g., jewelry) may be related or otherwise linked to a document data element 102a (e.g., TEST) and a places data element 102c (e.g., safety deposit box).

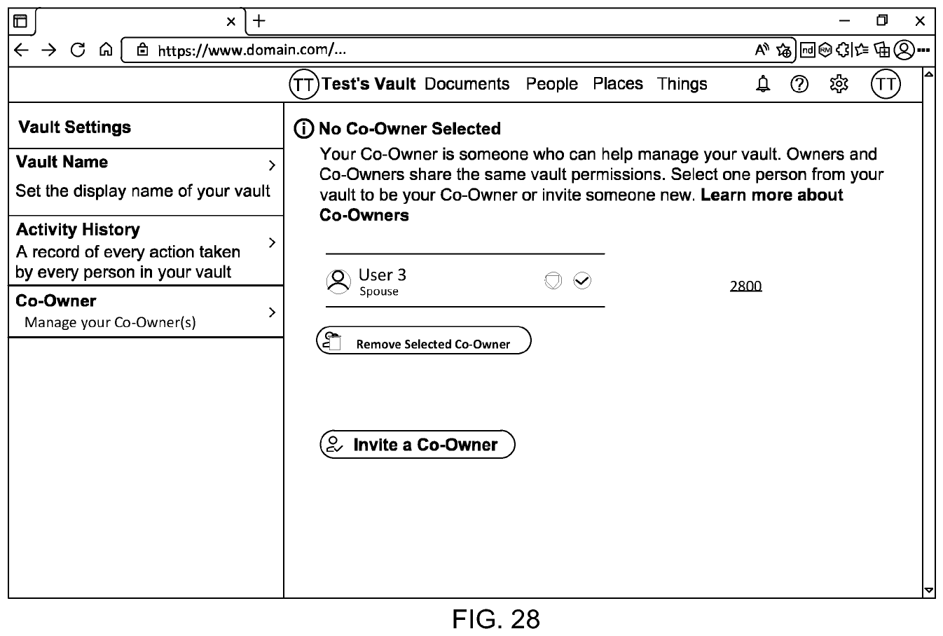

As illustrated in FIG. 28, the flexible referential data structure may enable an account (e.g., vault) owner to list one or more users as a co-owner via an interface 2800. In some examples, a co-owner may view, access, and perform anything an account owner may do. In some examples, a co-owner user may not remove the account (e.g., vault) owner user from the account. In some examples, an account (e.g., vault) owner user may remove a co-owner user from the account. In some examples, the flexible referential data structure may transfer the account (e.g., vault) from owner to co-owner if an owner becomes incapacitated. In some examples, a co-owner may initiate a release or a transfer of an owner's flexible referential data structure, as will be further described below.

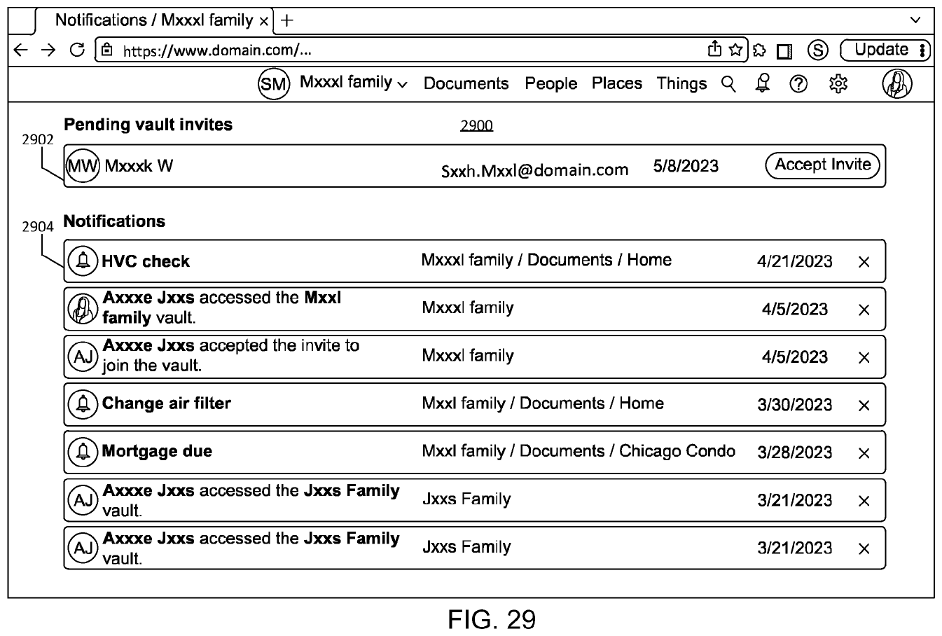

As illustrated in FIG. 29, the flexible referential data structure may enable a user who has been invited to another user's flexible referential data structures (either as a co-owner or invited with access to view specific items and/or one or more add/edit/delete permissions) to see such invitations in an exemplary interface 2900. While the flexible referential data structure may not require acceptance by another user for such invitations, the flexible referential data structure may require a key holder to acknowledge and/or accept the role. In some examples, interface 2900 may include both pending invitations 2902 in addition to other notifications 2904.

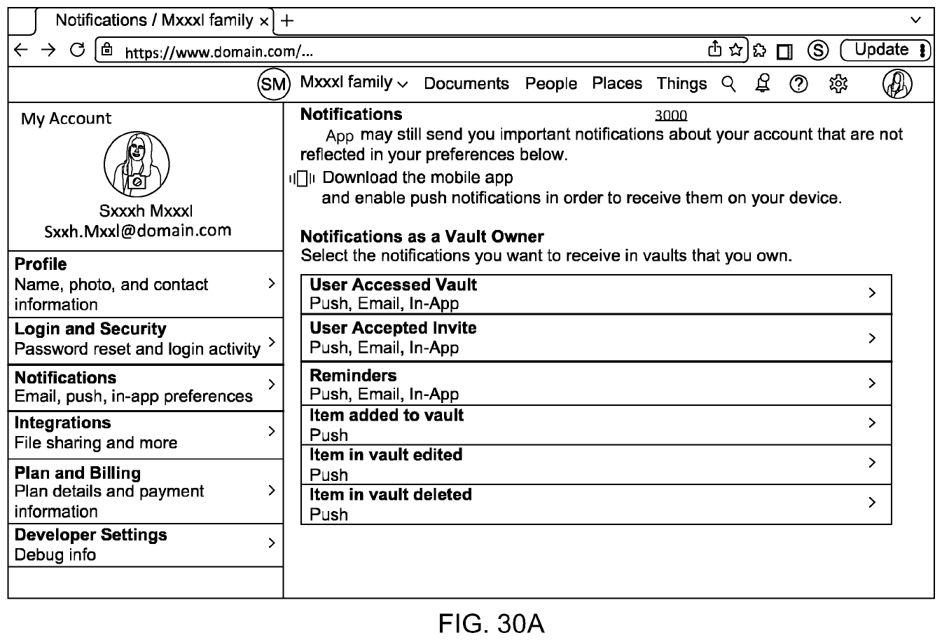

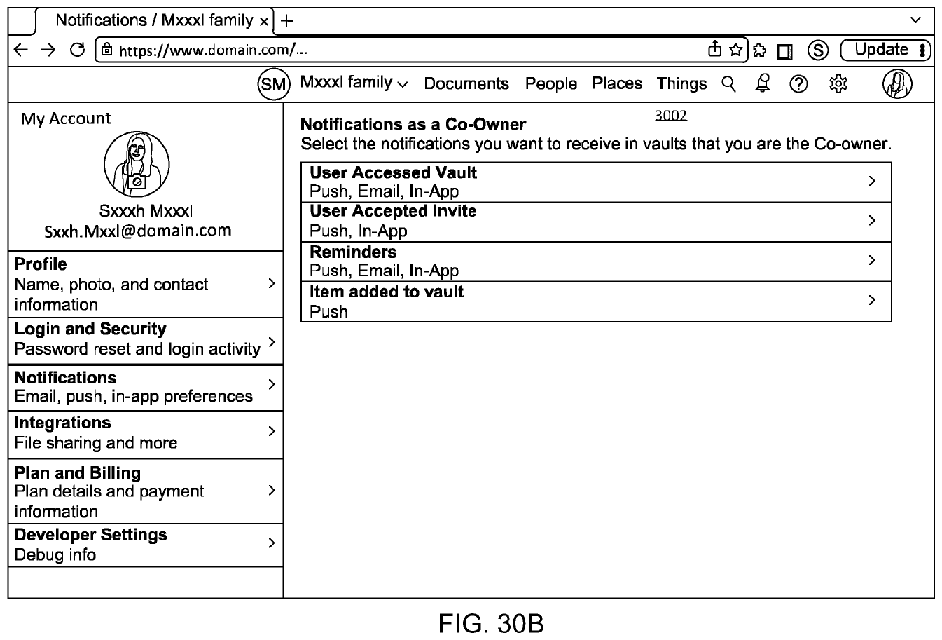

As illustrated in FIGS. 30A-34, the flexible referential data structures may enable a number of notifications. As shown in FIG. 30A, the flexible referential data structure may display an interface 3000 that may enable a user to set up types of notifications (e.g., when a user accesses the flexible referential data structure, when a user accepts an invite to the flexible referential data structure, reminders, when data elements are added to the flexible referential data structure, when data elements in the flexible referential data structure are edited, and/or when data elements in the flexible referential data structure are deleted). In some examples, the interface 3000 may enable a user to set up how such notifications may be sent to a user. For example, a user may enable push notifications (which may appear as a pop-up message), email notifications, short messaging service (SMS) notifications, multimedia messaging service (MMS) notifications, and/or in-app notifications.

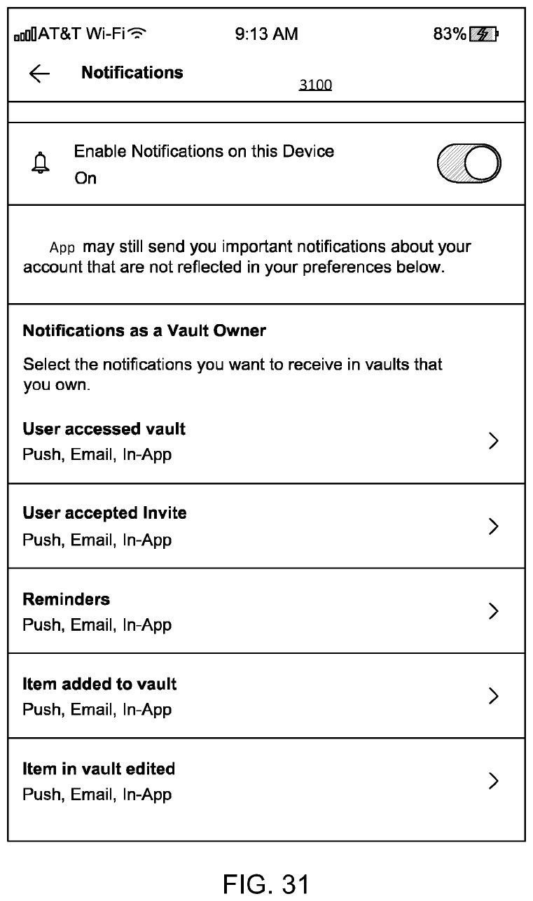

In some examples, the notification types may differ based on whether a user is an owner or a co-owner. For example, as shown in FIG. 30B, a co-owner may have different types of notifications (e.g., when a user accesses the flexible referential data structure, when a user accepts an invite to the flexible referential data structure, reminders, and/or when data elements are added to the flexible referential data structure) than an owner, as illustrated in interface 3002. In some examples, a co-owner may have the same methods of how such notifications may be sent to the user. In some examples, each user may select individualized methods of notification. As shown in FIG. 31, the flexible referential data structure may display a mobile interface 3100 with similar features as set forth with respect to FIG. 30A. In some examples, due to limited screen sizes associated with mobile devices, one or more features may not be presented on a mobile device screen, and the interface 3100 may be scrolled or otherwise interacted with (e.g., by a user) to display additional features.

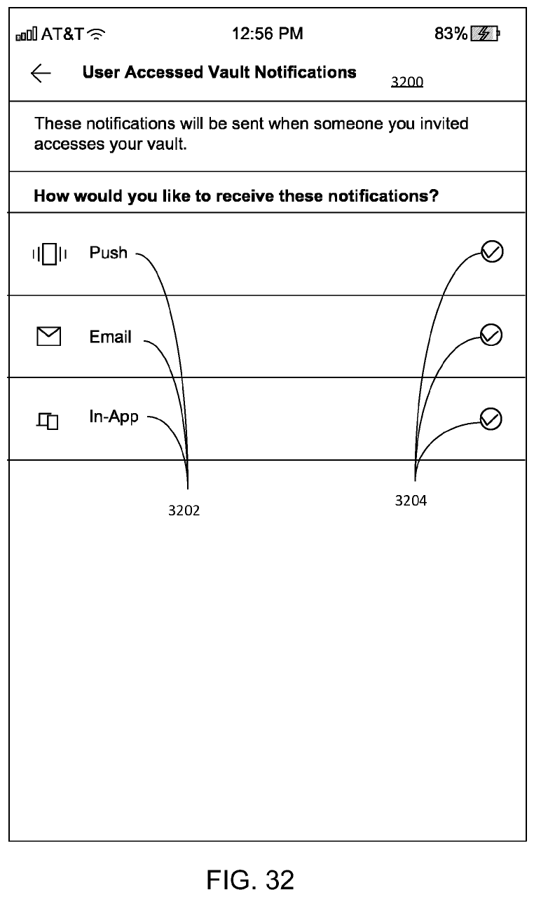

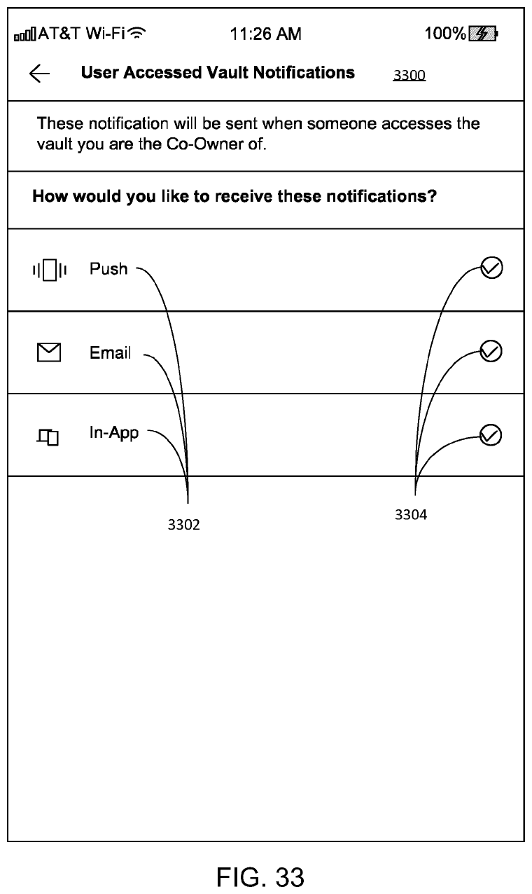

As shown in FIG. 32, upon selection of one of the types of notifications described with reference to FIG. 30A (e.g., owner notifications), the flexible referential data structure may display an interface 3200 including the various methods of notifications 3202 (e.g., push, email, in-app), and one or more selectable icons 3204. Upon selection of each selectable icon, the corresponding notification type may be enabled for that user. As shown in FIG. 33, upon selection of one of the types of notifications described with reference to FIG. 30B (e.g., co-owner notifications), the flexible referential data structure may display an interface 3300 including the various methods of notifications 3302 (e.g., push, email, in-app), and one or more selectable icons 3304. Upon selection of each selectable icon, the corresponding notification type may be enabled for that user.

Once a user has selected the types of notifications and methods for such notifications, notifications may be enabled for that user. In some examples, when events associated with the type of notifications occur (e.g., when a user accesses the flexible referential data structure, when a user accepts an invite to the flexible referential data structure, reminders, when data elements are added to the flexible referential data structure, when data elements in the flexible referential data structure are edited, and/or when data elements in the flexible referential data structure are deleted), a corresponding notification may be sent to the user according to the user-selected notifications methods. In some examples, the flexible referential data structure may provide such notifications in (or at near) real-time. In some examples, the flexible referential data structure may respond to user interactions with such notifications in (or at near) real-time.

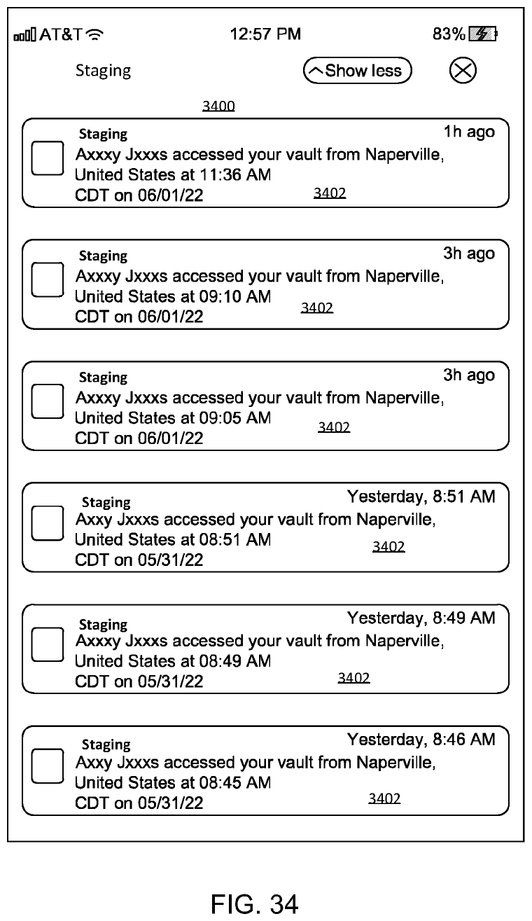

For example, FIG. 34 illustrates an interface having a number of push notifications 3402 associated with users accessing the flexible referential data structure at various times. In some examples, the notification may include which data element within the flexible referential data structure was accessed. In some examples, the location, time, date, and time zone associated with each access may be included in a push notification. In some examples, the user may be kept aware of all accesses, may quickly identify unlikely authorized access, and may adjust sharing and/or permissions accordingly.

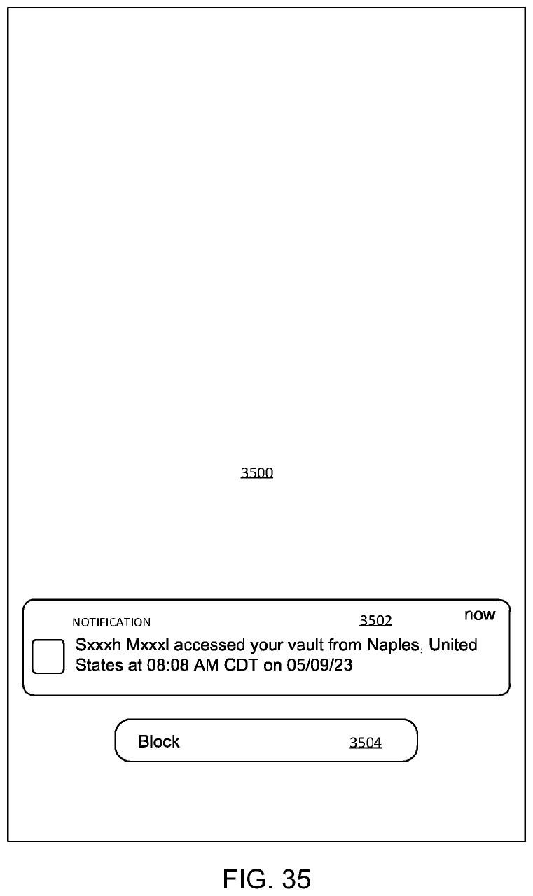

In some examples, a user may, based on such notifications, block someone that does not have authorized access or should no longer have authorized access. In some examples, a user may, based on such notifications, block someone that is attempting access from an unknown, foreign, or untrusted location. In some examples, a notification may be presented in associated with an interactive component. For example, as shown in FIG. 35, an interface 3500 displays a notification 3502 and an interactive button 3504. In the illustrated example of FIG. 35, the notification 3502 may be associated with an access or attempted access of the user's flexible referential data structure and the interactive button 3504 may be blocking function. In some examples, other interactive buttons or functions may be included such as, for example, temporarily restrict access, flag access attempt, limit access to a threshold number of accesses, report, etc.

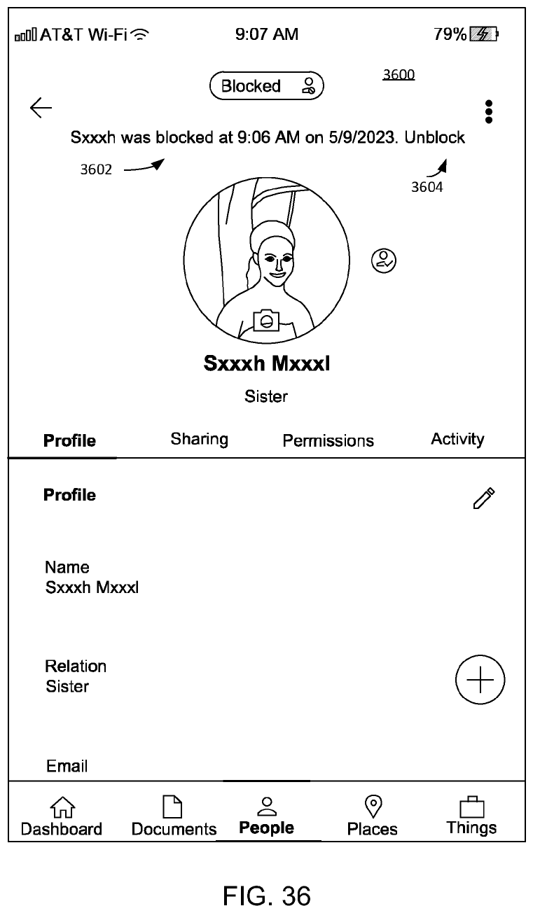

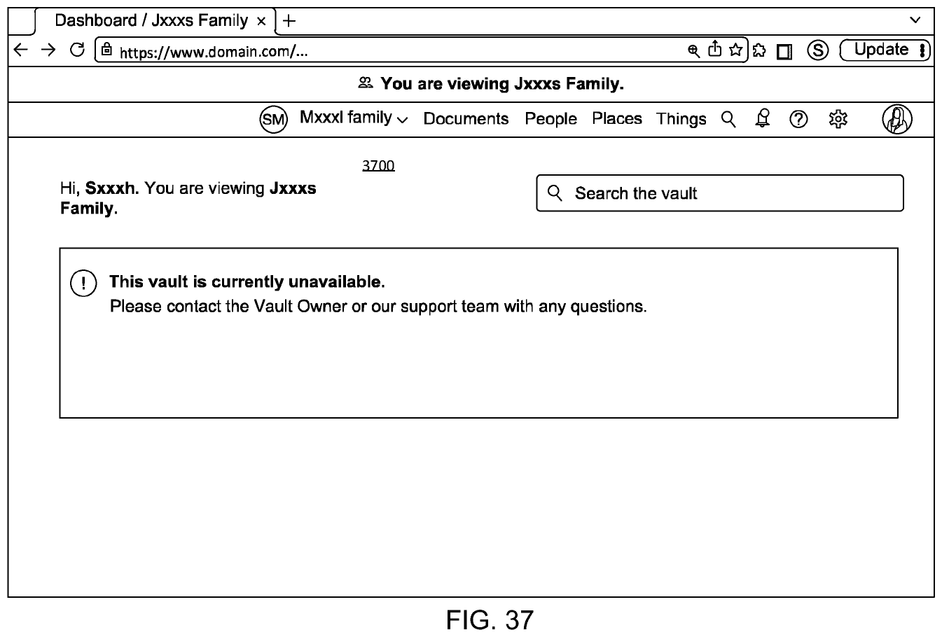

In some examples, the flexible referential data structure may display information associated with any interaction with the interactive button 3504 in connection with the user that attempted access, such as in a profile associated with that user. For example, FIG. 36 illustrates an interface 3600 identifying that a user 3602 was blocked. In some examples, the time and date associated with such blocking may be displayed. In some examples, an undo button 3604 may be displayed to reverse the previous interaction with the interactive button 3504 (e.g., unblock, lift temporarily restrictions on access, remove flag, remove threshold amount of accesses limitation, cancel report, etc.). In some examples, the flexible referential data structure may display the interface 3600 in response to interaction with the interactive button 3504. In some examples, a user may need to navigate to a user profile in order for interface 3600 to be displayed. As shown in FIG. 37, the flexible referential data structure may display interface 3700 to a user that has been blocked, temporarily restricted, flagged, or reported.

Because the data elements described herein may pertain to sensitive or otherwise secure information, the flexible referential data structure may notify an account owner and associated co-owner (if one exists) of various accesses or sharing of the underlying information. Furthermore, the flexible referential data structure may encrypt each individual data element 102 described herein with a unique encryption key. The flexible referential data structure may further encrypt those unique encryption keys with a global encryption key. In some examples, a separate system using a separate global encryption key is used to add an additional layer of security. In some examples, machine generated encryption keys (e.g., a global unique identifier) may be used in a process-wide encryption. In some examples, a first encryption key and a second encryption key may be machine generated for a single data element 102. In some examples, the first encryption key and the second encryption key may be used together (e.g., combined) to encrypt a data element 102. In some examples, the first encryption key and the second encryption key are individually encrypted with a process-wide (e.g., global) encryption key. In some such examples, the globally encrypted first encryption key and the globally encrypted second encryption key may be stored in separate locations (e.g., separate systems). In some examples, decryption of a data element 102 may involve a similar process as described above, but in reverse order.

The flexible referential data structure, through its data storage and interconnected related data elements 102 may provide a user driven search engine. In some examples, the search engine may search through information contained within the flexible referential data structure based on user inputted keywords and output matching data entries. In some examples, the matching data entries may only be retrieved and/or output if the user searching for such keywords has been provided shared access to the matching data entries. The flexible referential data structure may utilize the related data elements 102 set up as disclosed herein to more efficiently process data input into the search engine and locate matching data entries more quickly.

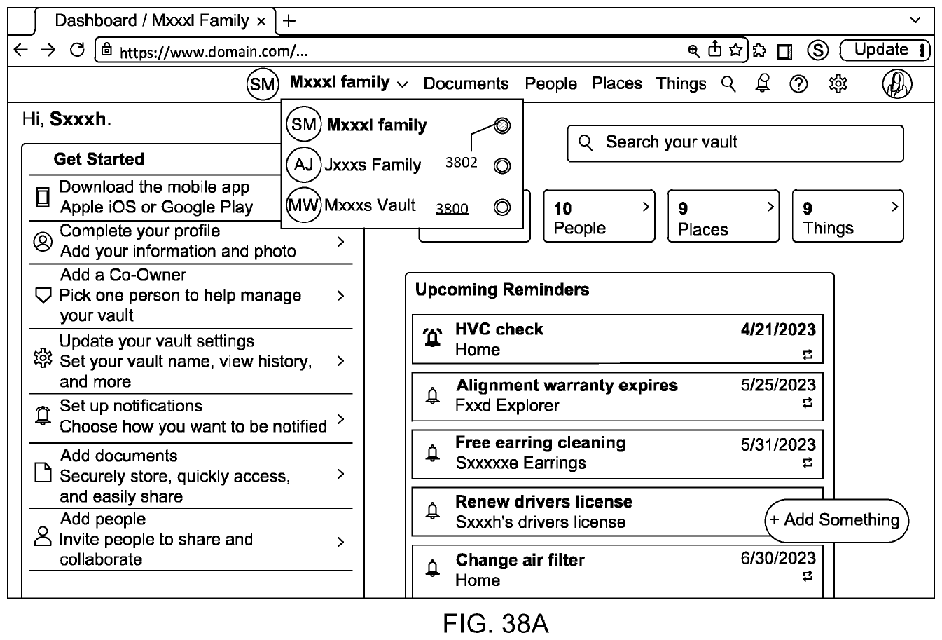

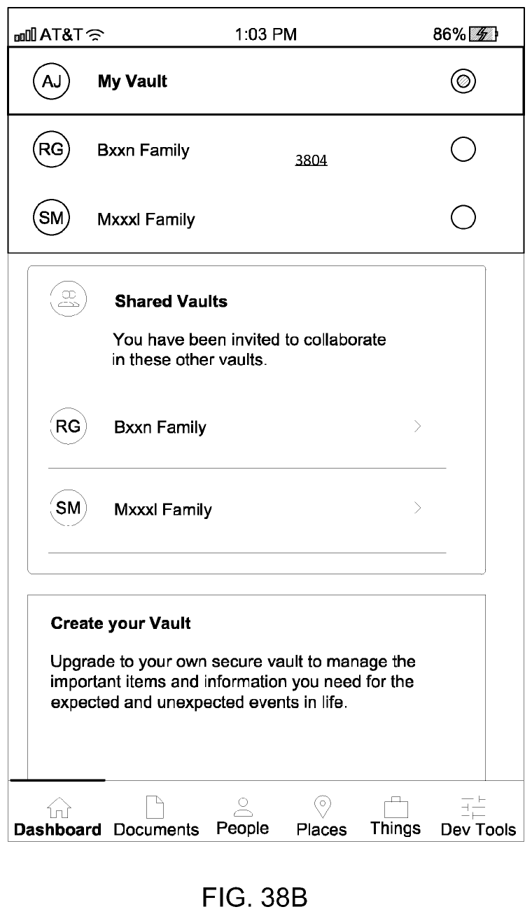

As shown in FIGS. 38A-38B, the flexible referential data structure may enable users to switch between multiple flexible referential data structures to which the user has access. For example, a user may have various sharing permissions enabled for multiple flexible referential data structures (e.g., the user's own vault, the Mxxxl Family vault, and the Jxxxs Family vault). As shown in FIG. 38A, the flexible referential data structure display a window 3800, which may enable to a user to select an icon 3802 from a list, and based on such a selection, direct the user to the respective flexible referential data structure and all the data elements to which that user has been provided access associated with that icon 3802. As shown in FIG. 38B, the flexible referential data structure may display a mobile interface 3804 with similar features as set forth with respect to FIG. 38A. In some examples, due to limited screen sizes associated with mobile devices, one or more features may not be presented on a mobile device screen, and the interface 3804 may be scrolled or otherwise interacted with (e.g., by a user) to display additional features.

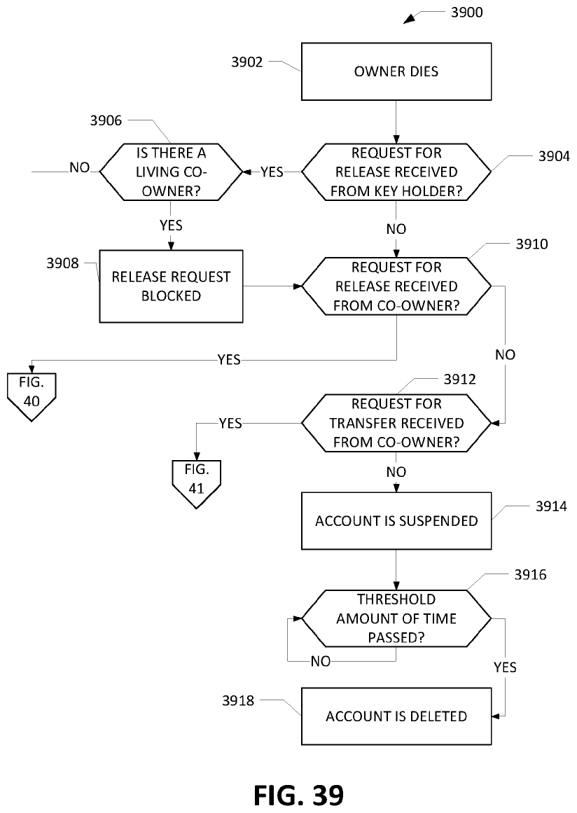

In some examples, an owner of a flexible referential data structure may pass away. In some such examples, other users (e.g., co-owners or key holders or a legal entity not previously designated as a co-owner or a key holder such as an attorney, a judge, or officer enforcing a court-order) may want or otherwise need access to the data elements 102 securely stored in the flexible referential data structure associated with the deceased owner. FIG. 39 is an exemplary process of a method 3900 for managing requests to release or transfer a flexible referential data structure. In some examples, a release is a procedure of providing a viewable-only version of the flexible referential data structure to whom the flexible referential data structure is released. In some examples, a transfer is a procedure of providing complete access, including editing and viewing privileges, to whom the flexible referential data structure is transferred. In some examples, a transfer transitions the responsibilities of the flexible referential data structure, including any billing or payment responsibilities, to whom the flexible referential data structure is transferred. Method 3900 may begin upon a notification that a flexible referential data structure owner has passed away (block 3902). In some examples, a key holder or a co-owner may send such a notification through a request to release or transfer the flexible referential data structure due to an owner's death.

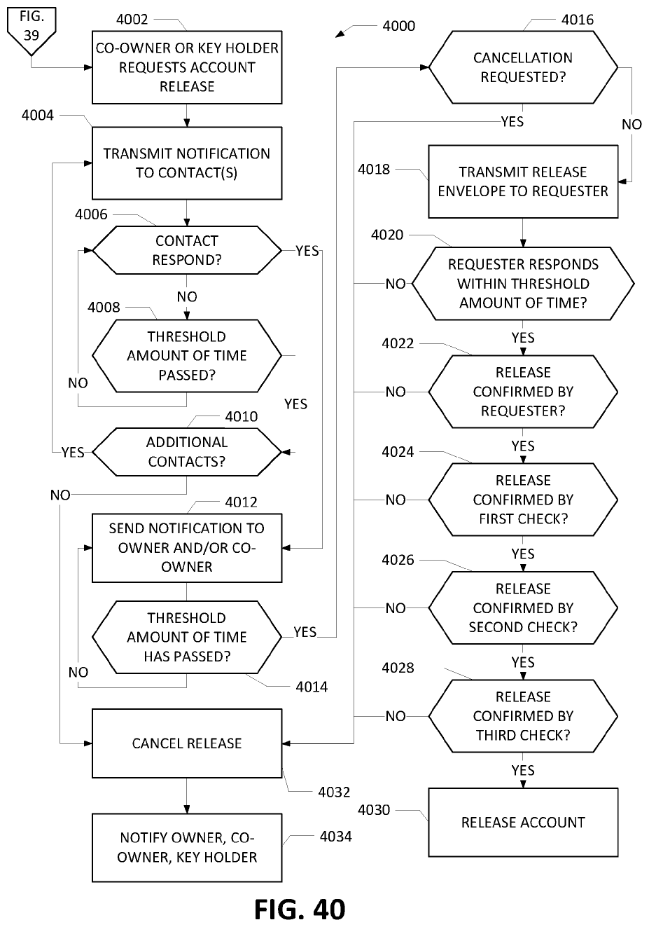

In some examples, the flexible referential data structure may utilize web crawlers to search for published obituaries relating to a flexible referential data structure owner. In some examples, the flexible referential data structure may receive a request from a key holder to release the flexible referential data structure to the key holder. Such a release may be temporary and may enable a key holder access to and/or retrieval of the data elements 102 stored in the flexible referential data structure. If the flexible referential data structure receives a request for a release from a key holder (block 3904: YES), then control proceed to block 3906. At block 3906, the flexible referential data structure may determine whether there is a living co-owner associated with the flexible referential data structure requested to be released. If there is no living co-owner associated with the flexible referential data structure requested to be released (block 3906: NO), then control proceeds to method 4000 as further described with reference to FIG. 40. If there is a living co-owner associated with the flexible referential data structure requested to be released (block 3906: YES), then control proceeds to block 3908. At block 3908, the flexible referential data structure may block the request to release the flexible referential data structure to the key holder (e.g., in view of the existing co-owner). After block 3908 or if the flexible referential data structure does not receive a request for a release from a key holder (block 3904: NO), control proceeds to block 3910.

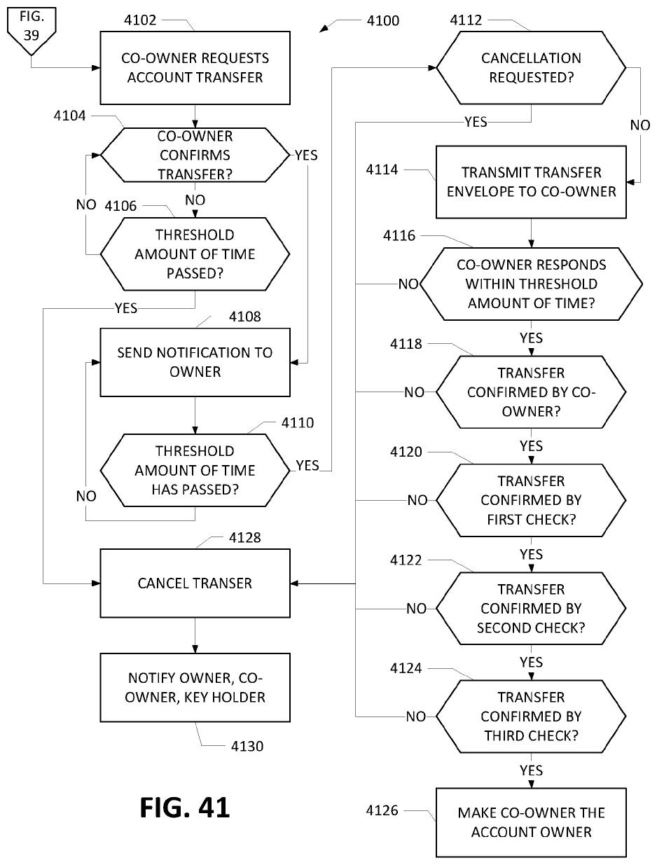

In some examples, the flexible referential data structure may receive a request from a co-owner to release the flexible referential data structure. If the flexible referential data structure receives a request for a release from a co-owner (block 3910: YES), then control proceeds to method 4000 as further described with reference to FIG. 40. If the flexible referential data structure does not receive a request for a release from a co-owner (block 3910: NO), then control proceeds to block 3912. In some examples, the flexible referential data structure may receive a request from a co-owner to transfer the flexible referential data structure to the co-owner. If the flexible referential data structure receives a request for a transfer from a co-owner (block 3912: YES), then control proceeds to method 4100 as further described with reference to FIG. 41. If the flexible referential data structure does not receive a request for a transfer from a co-owner (block 3912, NO), then control proceeds to block 3914.

In some examples, rather than wait for a request from a key holder or a co-owner, the flexible referential data structure may notify all key holders and co-owners that an owner's account is going to be suspended or otherwise deleted unless the key holder or co-owner intervenes via a release or transfer request. At block 3914, if the flexible referential data structure has not received a request to release or transfer the account associated with the deceased owner, the flexible referential data structure may suspend the account associated with the deceased owner. At block 3916, the flexible referential data structure may determine whether a threshold amount of time has passed. If the flexible referential data structure determines that a threshold amount of time has not yet passed (block 3916, NO), then control returns to block 3916. If the flexible referential data structure determines that a threshold amount of time has passed (block 3916, YES), the flexible referential data structure may delete the account associated with the deceased owner. Thereafter, method 3900 may cease. Method 3900 may be repeated. Method 3900 may be performed in parallel of behalf of one or more account owners simultaneously.

FIG. 40 is an exemplary process of a method 4000 for managing requests to release a flexible referential data structure. At block 4002, the flexible referential data structure may receive a request to release an account from a co-owner or a key holder. In some examples, the flexible referential data structure may merely identify that a request to release an account has already been received (e.g., from block 3906 or block 3910 of FIG. 39). In some examples, a death certificate is included in such a request. Based on receipt or identification of receipt of a request to release an account, the flexible referential data structure may transmit a notification to one or more contact(s) (block 4004). In some examples, the one or more contact(s) may be established by a user. In some examples, the one or more contact(s) may be key holders. In some examples, the one or more contact(s) may be determined by identifying which contacts have the greatest number of data elements shared by the user. In some examples, the one or more contact(s) may be finite (e.g., four). In some examples, the one or more contact(s) may be a user's entire contact list.

At block 4006, the flexible referential data structure may await response from the one or more contact(s). If a contact does not respond (block 4006: NO), then control proceeds to block 4008. At block 4008, the flexible referential data structure may await a threshold amount of time. If a threshold amount of time has not passed (block 4008: NO), then control returns to block 4006. If a threshold amount of time has passed (block 4008: YES), then control proceeds to block 4010. At block 4010, the flexible referential data structure may determine whether there are any additional contacts. If there are additional contacts (block 4010: YES), the control returns to block 4004.

If a contact responds (block 4006: YES), then control proceeds to block 4012. In some examples, the contact's response confirms that the release request is valid. At block 4012, the flexible referential data structure sends a notification to the owner and/or co-owner that the flexible referential data structure is to be released to a co-owner or key holder. If the owner and/or co-owner are not deceased, the notification may give the owner/co-owner an opportunity to cancel the release request. Therefore, at block 4014, the flexible referential data structure may wait a threshold amount of time to provide an owner/co-owner an opportunity to cancel the release request. If a threshold of time has not yet passed (block 4014: NO), then control returns to block 4012 to send a reminder notification to owner/co-owner. If a threshold amount of time has passed since sending one or more notifications to the owner/co-owner (block 4014: YES), then control proceed to block 4016. At block 4016, the flexible referential data structure may determine whether cancellation of the release has been requested. If cancellation has not been requested (block 4016: NO), then control proceeds to block 4018. At block 4018, the flexible referential data structure may transmit a release envelope to the requester (e.g., the co-owner or key holder that initiated the request at block 4002). At block 4020, the flexible referential data structure may wait a threshold amount of time for a response from the requester. If the flexible referential data structure determines that the requester responds in a threshold amount of time (block 4020: YES), then control proceeds to block 4022.

At block 4022, the flexible referential data structure may determine if the requester confirms the release. If the flexible referential data structure determines that the release is confirmed by the requester (block 4022: YES), then control proceeds to block 4024. At block 4024, the flexible referential data structure may process a number of additional checks to confirm the release, including confirming release via a first check (e.g., by a support entity). If the flexible referential data structure determines that the release is confirmed by the first check (block 4024: YES), then control proceeds to block 4026. At block 4026, the flexible referential data structure may process another additional check to confirm the release, including confirming release via a second check (e.g., by an experience entity such as a chief experience officer). If the flexible referential data structure determines that the release is confirmed by the second check (block 4026: YES), then control proceeds to block 4028. At block 4028, the flexible referential data structure may process another additional check to confirm the release, including confirming release via a third check (e.g., by an execution entity). If the flexible referential data structure determines that the release is confirmed by the third check (block 4028: YES), then control proceeds to block 4030. At block 4030, the flexible referential data structure may release the account to the requester.

If there are no additional contacts at block 4010 (block 4010: NO), if cancellation is requested at block 4016 (block 4016: YES), if the requester does not respond within a threshold amount of time at block 4020 (block 4020: NO), if the release is not confirmed by the requester at block 4022 (block 4022: NO), if the release is not confirmed by the first check at block 4024 (block 4024: NO), if the release is not confirmed by the second check at block 4026 (block 4026: NO), or if the release is not confirmed by the third check at block 4028 (block 4028: NO), then control proceeds to block 4032. At block 4032, the flexible referential data structure may cancel the release. The flexible referential data structure may transmit a notification notifying the owner, co-owner(s), and/or key holder(s) that the release request has been cancelled (block 4034). After either block 4030 or 4034, method 4000 may cease. Method 4000 may be repeated. Method 4000 may be performed in parallel with respect to one or more accounts simultaneously.

FIG. 41 is an exemplary process of a method 4100 for managing requests to transfer a flexible referential data structure. At block 4102, the flexible referential data structure may receive a request to transfer an account from an owner to a co-owner. In some examples, the flexible referential data structure may merely identify that a request to transfer an account has already been received (e.g., from block 3912 of FIG. 39). In some examples, a death certificate is included in such a request. Based on receipt or identification of receipt of a request to transfer an account, the flexible referential data structure may request confirmation by the co-owner. If the co-owner does not confirm the transfer (block 4104: NO), then control may proceed to block 4106. At block 4106, the flexible referential data structure may await a threshold amount of time. If a threshold amount of time has not passed (block 4106: NO), then control returns to block 4104. If the co-owner confirms the transfer (block 4104: YES), then control may proceed to block 4108.

At block 4108, the flexible referential data structure sends a notification to the owner that the flexible referential data structure is to be transfer to a co-owner. If the owner is not deceased, the notification may give the owner an opportunity to cancel the transfer request. Therefore, at block 4110, the flexible referential data structure may wait a threshold amount of time to provide an owner/co-owner an opportunity to cancel the transfer request. If a threshold of time has not yet passed (block 4110: NO), then control returns to block 4108 to send a reminder notification to owner/co-owner. If a threshold amount of time has passed since sending one or more notifications to the owner/co-owner (block 4110: YES), then control proceed to block 4112. At block 4112, the flexible referential data structure may determine whether cancellation of the transfer has been requested. If cancellation has not been requested (block 4112: NO), then control proceeds to block 4114. At block 4114, the flexible referential data structure may transmit a transfer envelope to the co-owner. At block 4116, the flexible referential data structure may wait a threshold amount of time for a response from the co-owner. If the flexible referential data structure determines that the co-owner responds in a threshold amount of time (block 4116: YES), then control proceeds to block 4118.

At block 4118, the flexible referential data structure may determine if the co-owner confirms the transfer. If the flexible referential data structure determines that the transfer is confirmed (block 4118: YES), then control proceeds to block 4120. At block 4120, the flexible referential data structure may process a number of additional checks to confirm the transfer, including confirming transfer via a first check (e.g., by a support entity). If the flexible referential data structure determines that the transfer is confirmed by the first check (block 4120: YES), then control proceeds to block 4122. At block 4122, the flexible referential data structure may process another additional check to confirm the transfer, including confirming transfer via a second check (e.g., by an experience entity such as a chief experience officer). If the flexible referential data structure determines that the transfer is confirmed by the second check (block 4122: YES), then control proceeds to block 4124. At block 4124, the flexible referential data structure may process another additional check to confirm the transfer, including confirming transfer via a third check (e.g., by an execution entity). If the flexible referential data structure determines that the transfer is confirmed by the third check (block 4124: YES), then control proceeds to block 4126. At block 4126, the flexible referential data structure may transfer the account from the owner to the co-owner by making the co-owner the account owner.

If a threshold amount of time has passed at block 4106 (block 4106: YES), if cancellation is requested at block 4112 (block 4112: YES), if the co-owner does not respond within a threshold amount of time at block 4116 (block 4116: NO), if the transfer is not confirmed by the co-owner at block 4118 (block 4118: NO), if the transfer is not confirmed by the first check at block 4120 (block 4120: NO), if the transfer is not confirmed by the second check at block 4122 (block 4122: NO), or if the transfer is not confirmed by the third check at block 4124 (block 4124: NO), then control proceeds to block 4128. At block 4128, the flexible referential data structure may cancel the transfer. The flexible referential data structure may transmit a notification notifying the owner, co-owner(s), and/or key holder(s) that the transfer request has been cancelled (block 4130). After either block 4126 or 4130, method 4100 may cease. Method 4100 may be repeated. Method 4100 may be performed in parallel with respect to one or more accounts simultaneously.

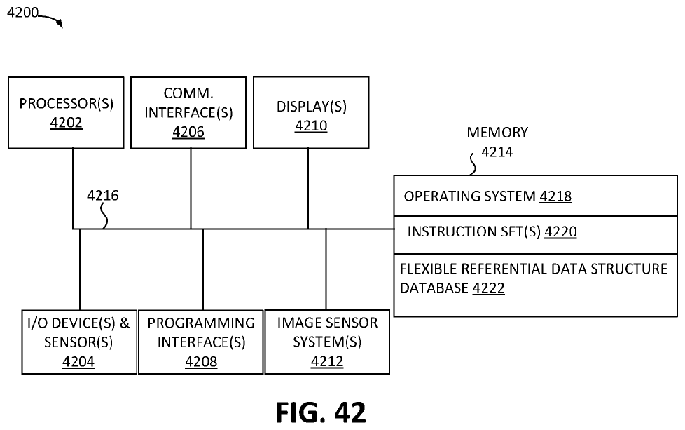

FIG. 42 is a block diagram of electronic device 4200 that may be used to implement the flexible referential data structures and methods of using the same disclosed herein. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some examples the device 4200 includes one or more processing units 4202 (e.g., microprocessors, ASICs, FPGAs, GPUs, CPUs, processing cores, and/or the like), one or more input/output (I/O) devices and sensors 4204, one or more communication interfaces 4206 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 4208, one or more display(s) 4210, one or more interior and/or exterior facing image sensor systems 4212, a memory 4214, and one or more communication buses 4216 for interconnecting these and various other components.

In some examples, the one or more communication buses 4216 include circuitry that interconnects and controls communications between system components. In some examples, the one or more I/O devices and sensors 4204 include at least one of an inertial measurement unit (IMU), an accelerometer, a magnetometer, a gyroscope, a thermometer, one or more microphones, one or more speakers, a haptics engine, and/or the like.

In some examples, the one or more programming interfaces 4208 may comprise the various interfaces described herein (e.g., FIGS. 1A-38B) with respect to the flexible referential data structures. In some examples, the one or more display(s) 4210 correspond to liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 4210 include a single display. In some examples, the one or more display(s) 4210 include one or more audio producing devices. In some examples, the one or more display(s) 4210 include one or more speakers, surround sound speakers, speaker-arrays, or headphones.

In some examples, the one or more image sensor systems 4212 are configured to obtain image data that corresponds to at least a portion of a physical environment. For example, the one or more image sensor systems 4212 may include one or more RGB cameras (e.g., with a complimentary metal-oxide-semiconductor (CMOS) image sensor or a charge-coupled device (CCD) image sensor), monochrome cameras, IR cameras, and/or the like. In some examples, the one or more image sensor systems 4212 further include illumination sources that emit light, such as a flash. In some examples, the one or more image sensor systems 4212 further include an on-camera image signal processor (ISP) configured to execute a plurality of processing operations on the image data.

In some examples, the memory 4214 may include high-speed random-access memory, such as DRAM, SRAM, DDR RAM, or other random-access solid-state memory devices. In some examples, the memory 4214 may include non-volatile memory, such as one or more magnetic disk storage devices, optical disk storage devices, flash memory devices, or other non-volatile solid-state storage devices. The memory 4214 may optionally includes one or more storage devices remotely located from the one or more processing units 4202. The memory 4214 may comprise a non-transitory computer readable storage medium.

In some examples, the memory 4214 or the non-transitory computer readable storage medium of the memory 4214 stores an optional operating system 4218 and one or more instruction set(s) 4220. The operating system 4218 includes procedures for handling various basic system services and for performing hardware dependent tasks. In some examples, the instruction set(s) 4220 include executable software defined by binary information stored in the form of electrical charge. In some examples, the instruction set(s) 4220 are software that is executable by the one or more processing units 4202 to carry out one or more of the techniques described herein.

In some examples, the memory 4214 further comprises a flexible referential data structure database 4222. The flexible referential data structure database 4222 may store the one or more flexible referential data structures, the corresponding data elements, information associated with each user as described herein.

Although the instruction set(s) 4220 and the flexible referential data structure database 4222 are shown as residing on a single device, it should be understood that in some examples, any combination of the elements may be located in separate computing devices. For example, the flexible referential data structure database 4222 may be housed across many networked storage devices in order to store each user's data elements within their own flexible referential data structures. Moreover, FIG. 42 is intended more as functional description of the various features which are present in a particular example as opposed to a structural schematic of the examples described herein. As recognized by those of ordinary skill in the art, items shown separately could be combined and some items could be separated. The actual number of instructions sets and how features are allocated among them may vary from one example to another and may depend in part on the particular combination of hardware, software, and/or firmware chosen for a particular example.

It will be appreciated that the examples described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

Numerous specific details are set forth herein to provide a thorough understanding of the disclosed subject matter. However, those skilled in the art will understand that the disclosed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention(s).

1. A method comprising:
receiving, from a first user, an indication to provide a second user access to a data element;
providing an interactive list of data elements associated with the first user;
receiving input indicating selection of one or more data elements from the list of data elements;
providing access to the selected one or more data elements to the second user;
providing an indication identifying the one or more data elements as being accessible to the second user; and
providing an indication identifying one or more other data elements not accessible to the second user.

2. The method of claim 1, further comprising:
providing an interactive list of other users;
receiving input indicating selection of one or more users from the list of other users;
providing access to the data element to the selected one or more users;
providing an indication identifying the selected one or more users as having access to the data element; and
providing an indication identifying one or more users that do not have access to the data element.

3. The method of claim 1, further comprising:
displaying a second list of data elements comprising both the indication identifying the one or more data elements as being accessible to the second user and the indication identifying the one or more other data elements not accessible to the second user.

4. The method of claim 3, wherein the displaying the second list of data elements is displayed to the first user.

5. The method of claim 3, further comprising:
searching, based on a received inquiry, the second list of data elements for one or more data elements that match criteria set forth in the received inquiry; and
displaying a third list of data elements comprising the one or more data elements that match the criteria set forth in the received inquiry.

6. The method of claim 1, further comprising:
displaying, to the second user, the indication identifying the one or more data elements as being accessible to the second user; and
refraining from displaying, to the second user, the indication identifying the one or more other data elements not accessible to the second user.

7. The method of claim 1, further comprising:
transmitting, to the second user and prior to receiving the indication to provide the second user access to the data element, an invitation to join a data structure associated with the first user.

8. The method of claim 1, further comprising:
receiving, from the first user, one or more data elements; and
generating, based on the one or more data elements, a data structure, wherein the data structure comprises an association between the one or more data elements and the first user.

9. The method of claim 8, further comprising:
receiving, from the first user, an indication to associate a first data element from the list of data elements with a second data element from the list of data elements; and
updating the data structure to include an association between the first data element and the second data element.

10. (canceled)

11. (canceled)

12. The method of claim 1, further comprising:
receiving a request to associate a data structure corresponding to the first user with the second user;
transmitting a notification to the first user;
based on a threshold amount of time passing without receiving a cancellation request from the first user, transmitting a digital envelope triggering an association between the data structure and the second user;
performing a check process to confirm association between the data structure and the second user; and
based on the check process satisfying a criterion, generating an association between the data structure and the second user.

13. The method of claim 12, wherein the request to associate the data structure corresponding to the first user with the second user comprises a request to release the data structure to the second user.

14. The method of claim 12, wherein the request to associate the data structure corresponding to the first user with the second user comprises a request to transfer the data structure to the second user.

15. The method of claim 12, further comprising:
based receiving the cancellation request from the first user within the threshold amount of time, refraining from generating the association between the data structure and the second user.

16. The method of claim 15, further comprising:
transmitting a notification, to the first user, of the refraining from generating the association between the data structure and the second user.

17. The method of claim 12, further comprising
based on the check process failing to satisfy the criterion, refraining from generating the association between the data structure and the second user.

18. The method of claim 17, further comprising:
transmitting a notification, to the first user, of the refraining from generating the association between the data structure and the second user.

19. A computer readable storage medium storing instructions that, when executed by one or more processors, cause performance of:
receiving, from a first user, an indication to provide a second user access to a data element;
providing an interactive list of data elements associated with the first user;
receiving input indicating selection of one or more data elements from the list of data elements;
providing access to the selected one or more data elements to the second user;
providing an indication identifying the one or more data elements as being accessible to the second user; and
providing an indication identifying one or more other data elements not accessible to the second user.

20. A system comprising:
one or more processors; and
memory storing instructions that, when executed by the one or more processors, cause the system to:
receive, from a first user, an indication to provide a second user access to a data element;
provide an interactive list of data elements associated with the first user;
receive input indicating selection of one or more data elements from the list of data elements;
provide access to the selected one or more data elements to the second user;
provide an indication identifying the one or more data elements as being accessible to the second user; and
provide an indication identifying one or more other data elements not accessible to the second user.

21. The system of claim 20, further comprising:
transmitting, to the second user and prior to receiving the indication to provide the second user access to the data element, an invitation to join a data structure associated with the first user.

22. The storage medium of claim 19, wherein the instructions, when executed, cause performance of:
transmitting, to the second user and prior to receiving the indication to provide the second user access to the data element, an invitation to join a data structure associated with the first user.
